(19) United States
(12) Patent Application Publication
(10) Pub. No.: US 2021/0304417 A1
(43) Pub. Date: Sep. 30, 2021

(54) OBSERVATION DEVICE AND OBSERVATION METHOD

(71) Applicant: Panasonic Intellectual Property Management Co., Ltd., Osaka (JP)

(72) Inventors: Hiroya KUSAKA, Hyogo (JP); Akihiro NODA, Osaka (JP); Yuki MARUYAMA, Osaka (JP); Taro IMAGAWA, Osaka (JP)

(21) Appl. No.: 17/346,582

(22) Filed: Jun. 14, 2021

Related U.S. Application Data
(63) Continuation of application No. PCT/JP2019/046259, filed on Nov. 27, 2019.

(30) Foreign Application Priority Data
Dec. 19, 2018 (JP) 2018-237093

(51) Int. Cl. G06T 7/13; G06T 7/223; G06T 7/11

(52) U.S. Cl. CPC G06T 7/13; G06T 7/223; G06T 2207/20164; G06T 2207/10016; G06T 7/11

(57) ABSTRACT

An observation method includes: displaying video of a subject; receiving designation of at least one point in the video; determining an area or edge in the video based on the point; setting, in the video, observation point candidates in the area or on the edge; evaluating an image of each observation block candidate having a center point that is a corresponding observation point candidate, eliminating any observation point candidates not satisfying conditions, and setting remaining observation point candidates to a plurality of observation points; and observing a movement of the subject itself applied with an certain external load at each observation point. The conditions are that (i) the subject is in a corresponding observation block candidate, (ii) image quality of the observation block candidate is good without temporal deformation or blur, (iii) a displacement of the observation block candidate is not greater than that of any other observation block candidates.

### CROSS REFERENCE TO RELATED APPLICATIONS

This application is a U.S. continuation application of PCT International Patent Application Number PCT/JP2019/046259 filed on Nov. 27, 2019, claiming the benefit of priority of Japanese Patent Application Number 2018-237093 filed on Dec. 19, 2018, the entire contents of which are hereby incorporated by reference.

### BACKGROUND

### 1. Technical Field

The present disclosure relates to an observation method and an observation device for observing a movement of a subject.

### 2. Description of the Related Art

For inspection of infrastructure, visual inspection methods using laser or a camera are used. For example, Japanese Unexamined Patent Application Publication No. 2008-139285 discloses a crack width measurement method for a structure or a product that uses an image processing technique in which a monochrome image processing is performed on an image or video taken by a camera, several kinds of filtering operations are performed to selectively extract a crack, and the width of the crack is measured by crack analysis.

### SUMMARY

In accordance with an aspect of the present disclosure, an observation method comprising: displaying a video of a subject, the video being obtained by imaging the subject; receiving a designation of at least one point in the video of the subject displayed; determining an area or edge in the video of the subject based on the at least one point; setting, in the video of the subject, a plurality of observation point candidates in the area determined or on the edge determined; evaluating an image of each of a plurality of observation block candidates each having a center point that is a corresponding one of the plurality of observation point candidates, eliminating any observation point candidate not satisfying observation point conditions from the plurality of observation point candidates, and setting remaining observation point candidates among the plurality of observation point candidates to a plurality of observation points; and observing a movement of the subject itself at each of the plurality of observation points, the movement resulting from applying an certain external load to the subject in the video of the subject, wherein the observation point conditions for each of the plurality of observation point candidates are that (i) the subject is present in an observation block candidate corresponding to the observation point candidate, (ii) image quality of the observation block candidate is good without temporal deformation or temporal blur, (iii) a displacement of the observation block candidate is observed as not greater than a displacement of any other observation block candidates among the plurality of observation block candidates.

Note that these comprehensive or specific aspects may be realized by a system, a device, a method, an integrated circuit, a computer program, or a non-transitory computer-readable recording medium such as a Compact Disc-Read Only Memory (CD-ROM), or may be implemented by any desired combination of systems, methods, integrated circuits, computer programs, or recording media.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a schematic diagram showing an example of an observation system according to Embodiment 1;

FIG. 2 is a block diagram showing an example of a functional configuration of the observation system according to Embodiment 1;

FIG. 3 is a flowchart showing an example of an operation of an observation device according to Embodiment 1;

FIG. 4 is a diagram showing an example of a video of a subject displayed by a display;

FIG. 5 is a diagram showing an example of at least one point designated in the video of the subject displayed on the display;

FIG. 6 is a diagram showing an example of an observation area set based on the at least one point designated in the video by a user;

FIG. 7 is an enlarged view of the observation area shown in FIG. 6;

FIG. 8 is a diagram for illustrating an example of the calculation of a movement of an observation block between two consecutive frames;

FIG. 9 is a diagram showing an example of an approximation curve for an evaluation value calculated according to the formula shown in FIG. 8;

FIG. 10 is a flowchart showing an example of a detailed process flow of a setting step;

FIG. 11 is a diagram showing an example of the setting of a plurality of observation point candidates in an observation area;

FIG. 12 is a diagram showing an example in which all of the plurality of observation point candidates shown in FIG. 11 are set as an observation point;

FIG. 13 is a diagram showing an example in which a plurality of observation point candidates set in an observation area include observation point candidates that do not satisfy an observation point condition;

FIG. 14 is a diagram showing an example in which a plurality of observation points are set by eliminating the observation point candidates that do not satisfy an observation point condition of the plurality of observation point candidates from the observation point candidates;

FIG. 15 is a diagram showing another example in which a plurality of observation point candidates set in an observation area include observation point candidates that do not satisfy an observation point condition;

FIG. 16 is a diagram showing another example in which a plurality of observation points are set by eliminating the observation point candidates that do not satisfy an observation point condition of the plurality of observation point candidates from the observation point candidates;

FIG. 17 is a diagram showing another example of the at least one point designated in the video of the subject displayed on the display;

FIG. 18 is a diagram showing another example of the observation area set based on the at least one point designated in the video by the user;

FIG. 19 is a diagram showing another example of the at least one point designated in the video of the subject displayed on the display;

FIG. 20 is a diagram showing another example of the observation area set based on the at least one point designated in the video by the user;

FIG. 21 is a diagram showing another example of the observation area set based on the at least one point designated in the video by the user;

FIG. 22 is a diagram showing another example of the observation area set based on the at least one point designated in the video by the user;

FIG. 23 is a diagram showing an example of two or more observation areas set based on three or more points designated in the video by the user;

FIG. 24 is a diagram showing another example of two or more observation areas set based on three or more points designated in the video by the user;

FIG. 25 is a diagram showing an example of the setting of a re-set area by a setting unit;

FIG. 26 is a diagram showing an example of the re-setting of a plurality of observation points in the re-set area by the setting unit;

FIG. 27 is a schematic diagram showing an example of an observation system according to Embodiment 2;

FIG. 28 is a diagram showing an example of a video of a subject displayed on the display;

FIG. 29 is a diagram showing an example of a plurality of observation points set on one edge that overlaps with at least one point designated by the user;

FIG. 30 is a diagram showing an example of a plurality of observation points set between one edge that overlaps with at least one point designated by the user and another edge that is continuous with the one edge;

FIG. 31 is a diagram showing another example of a plurality of observation points set on two edges that overlap with (i) one point designated by the user or (ii) two or more points designated by the user, respectively;

FIG. 32 is a diagram showing another example of a plurality of observation points set between two edges that overlap with (i) one point designated by the user or (ii) two or more points designated by the user, respectively;

FIG. 33 is a block diagram showing an example of a configuration of an observation device according to another embodiment; and

FIG. 34 is a flowchart showing an example of an operation of an observation device according to the other embodiment.

### DETAILED DESCRIPTION OF THE EMBODIMENTS

(Overview of Present Disclosure)

An overview of an aspect of the present disclosure is as follows.

In accordance with an aspect of the present disclosure, an observation method comprising: displaying a video of a subject, the video being obtained by imaging the subject; receiving a designation of at least one point in the video of the subject displayed; determining an area or edge in the video of the subject based on the at least one point; setting, in the video of the subject, observation point candidates in the area determined or on the edge determined; evaluating an image of each of a plurality of observation block candidates each having a center point that is a corresponding one of the observation point candidates, eliminating any observation point candidate not satisfying observation point conditions from the observation point candidates, and setting remaining observation point candidates among the observation point candidates to observation points; and observing a movement of the subject at each of the observation points, the movement resulting from applying an certain external load to the subject in the video of the subject, wherein the observation point conditions for each of the observation point candidates are that (i) the subject is present in an observation block candidate corresponding to the observation point candidate, (ii) image quality of the observation block candidate is good without temporal deformation or temporal blur, (iii) a displacement of the observation block candidate is observed as not greater than a displacement of any other observation block candidates among the plurality of observation block candidates.

According to the method described above, by designating at least one point in the video of the subject, the user can determine an area or edge in the video, and easily set a plurality of observation points in the determined area or on the determined edge. Therefore, the user can easily observe a movement of the subject.

For example, in the observation method in accordance with the aspect of the present disclosure, it is possible that a total number of the observation points is more than a total number of the at least one point.

With this configuration, the user can easily set a plurality of observation points in an area of the subject in which the user wants to observe the movement of the subject itself by designating at least one point in the video.

For example, in the observation method in accordance with the aspect of the present disclosure, it is also possible that the area determined based on the at least one point is a quadrilateral area having a vertex in vicinity of the at least one point.

With this configuration, the user can easily designate an area of the subject in which the user wants to observe the movement of the subject itself.

For example, in the observation method in accordance with the aspect of the present disclosure, it is further possible that the area determined based on the at least one point is a round or quadrilateral area having a center in vicinity of the at least one point.

With this configuration, the user can easily designate an area of the subject in which the user wants to observe the movement of the subject itself.

For example, in the observation method in accordance with the aspect of the present disclosure, it is still further possible that the area determined based on the at least one point is obtained by segmenting the video of the subject based on a feature of the video of the subject, the area being identified as a part of the subject.

With this configuration, for example, the user can easily designate an area of the subject in which the user wants to observe the movement of the subject itself.

For example, in the observation method in accordance with the aspect of the present disclosure, it is still further possible that the area determined based on the at least one point is an area closest to the at least one point or an area including the at least one point among a plurality of areas identified as a plurality of subjects.

With this configuration, when there are a plurality of subjects in the video, a subject whose movement the user wants to observe can be easily designated by designating at least one point in the vicinity of the subject whose movement the user wants to observe or on the subject whose movement the user wants to observe among these subjects.

For example, in the observation method in accordance with the aspect of the present disclosure, it is still further possible that the observation points are set on the edge determined based on the at least one point.

With this configuration, when the subject is an elongated object, such as a cable, a wire, a steel frame, a steel material, a pipe, a pillar, a pole, or a bar, the user can easily set a plurality of observation points on an edge of the subject whose movement the user wants to observe by designating at least one point in the video.

For example, in the observation method in accordance with the aspect of the present disclosure, it is still further possible that the edge determined based on the at least one point is an edge closest to the at least one point or an edge overlapping the at least one point among a plurality of edges identified in the video of the subject.

With this configuration, when there are a plurality of edges in the video, the user can easily designate an edge whose movement the user wants to observe by designating at least one point in the vicinity of the edge whose movement the user wants to observe or on the edge whose movement the user wants to observe among these edges.

For example, in the observation method according to the aspect of the present disclosure, in the setting of a plurality of observation points, a plurality of observation point candidates may be set in the video based on the at least one point designated, and a plurality of observation points may be set by eliminating any observation point candidates that does not satisfy an observation point condition from the plurality of observation point candidates.

According to the method described above, an observation point candidate that satisfies an observation point condition can be set as an observation point. The observation point condition is a condition for determining an area that is suitable for observation of the movement of the subject. More specifically, in the method described above, by determining whether an observation point candidate satisfies an observation point condition or not, an area (referred to as an inappropriate area, hereinafter) that is not suitable for observation of the movement of the subject, such as an area in which a blown-out highlight or blocked-up shadow has occurred, an obscure area, or an area in which a foreign matter adheres to the subject, is determined in the video. Therefore, according to the method described above, even if a plurality of observation point candidates are set in an inappropriate area, the inappropriate area can be determined, and a plurality of observation points can be set by eliminating the observation point candidates set in the inappropriate area.

For example, in the observation method in accordance with the aspect of the present disclosure, it is still further possible that displaying, in the video of the subject, a satisfying degree of each of the observation points, the satisfying degree indicating how much the observation point satisfies the observation point conditions.

With this configuration, for example, the user can select observation points having a satisfying degree within a predetermined range from among the plurality of observation points by referring to the satisfying degree of each of the plurality of observation points concerning an observation point condition, and set the observation points as the plurality of observation points.

For example, in the observation method according to the aspect of the present disclosure, furthermore, the plurality of observation points may be re-set based on the result of the observation of the movement of each of the plurality of observation points.

With this configuration, for example, when there is any observation point whose movement is different from those of the other observation points in the plurality of observation points, the plurality of observation points may be re-set in such a manner that the density of observation points is higher in a predetermined area including the observation point having the different movement. In the vicinity of the observation point whose movement is different from those of the other observation points, a strain has occurred. Therefore, by setting a plurality of observation points with a higher density in a predetermined area including the observation point having the different movement, the part where the strain has occurred can be precisely determined.

An observation device according to an aspect of the present disclosure includes a display that displays a video of a subject obtained by imaging the subject, a receiver that receives a designation of at least one point in the displayed video, a setting unit that determines an area or edge in the video based on the at least one point designated and sets, in the video, a plurality of observation points in the determined area or on the determined edge, and an observer that observes a movement of each of the plurality of observation points.

With the configuration described above, the observation device can determine an area or edge in a video of a subject based on at least one point designated in the video by a user, and easily set a plurality of observation points in the determined area or on the determined edge.

Note that these comprehensive or specific aspects may be realized by a system, an apparatus, a method, an integrated circuit, a computer program, or a non-transitory recording medium such as a computer-readable recording disc, or may be implemented by any desired combination of systems, apparatuses, methods, integrated circuits, computer programs, or recording media. The computer-readable recording medium includes, for example, a non-volatile recording medium such as a CD-ROM. Additionally, the apparatus may be constituted by one or more sub-apparatuses. If the apparatus is constituted by two or more sub-apparatuses, the two or more apparatuses may be disposed within a single device, or may be distributed between two or more distinct devices. In the present specification and the scope of claims, “apparatus” can mean not only a single apparatus, but also a system constituted by a plurality of sub-apparatuses.

The observation method and the observation device according to the present disclosure will be described hereinafter in detail with reference to the drawings.

Note that the following embodiments describe comprehensive or specific examples of the present disclosure. The numerical values, shapes, constituent elements, arrangements and connection states of constituent elements, steps (processes), orders of steps, and the like in the following embodiments are merely examples, and are not intended to limit the present disclosure. Additionally, of the constituent elements in the following embodiments, constituent elements not denoted in the independent claims, which express the broadest interpretation, will be described as optional constituent elements.

In the following descriptions of embodiments, the expression “substantially”, such as “substantially identical”, may be used. For example, “substantially identical” means that primary parts are the same, that two elements have common properties, or the like.

Additionally, the drawings are schematic diagrams, and are not necessarily exact illustrations. Furthermore, constituent elements that are substantially the same are given the same reference signs in the drawings, and redundant descriptions may be omitted or simplified.

### Embodiment 1

In the following, an observation method and the like according to Embodiment 1 will be described.

[1-1. Overview of Observation System]

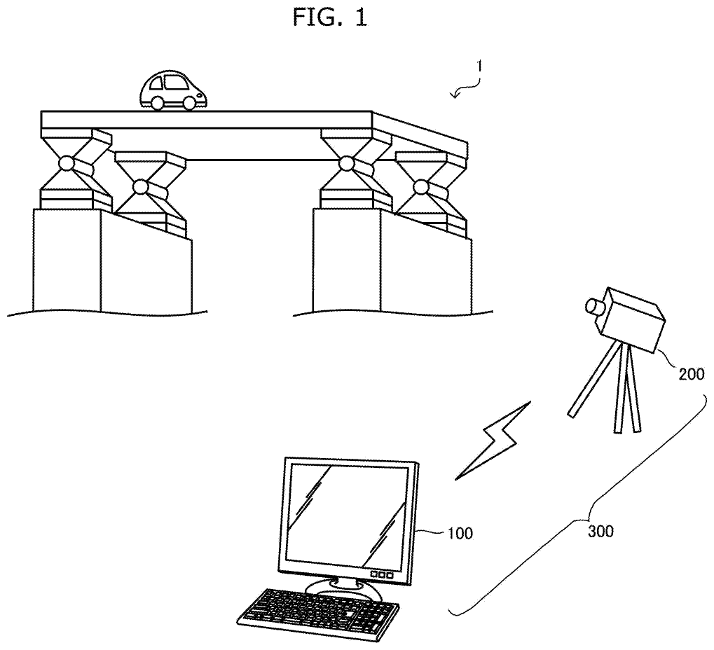

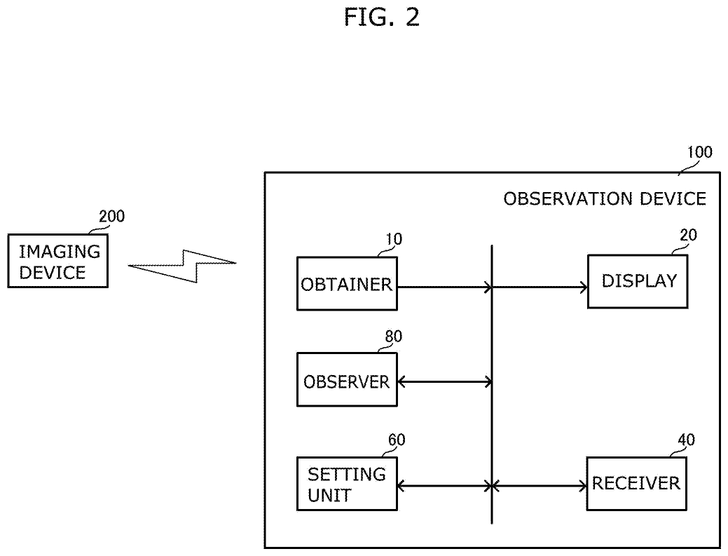

First, an overview of an observation system according to Embodiment 1 will be described in detail with reference to FIGS. 1 and 2. FIG. 1 is a schematic diagram showing an example of observation system 300 according to this embodiment. FIG. 2 is a block diagram showing an example of a functional configuration of observation system 300 according to this embodiment.

Observation system 300 is a system that takes a video (hereinafter, “video” refers to one or more images) of subject 1, receives a designation of at least one point in the taken video, sets a plurality of observation points that are more than the designated point(s) in the video based on the designated point(s), and observes a movement of each of the plurality of observation points. Observation system 300 can detect a part of subject 1 where a defect, such as a strain or a crack, can occur or has occurred by observing a movement of each of a plurality of observation points in a taken video of subject 1.

Subject 1 may be a structure, such as a building, a bridge, a tunnel, a road, a dam, an embankment, or a sound barrier, a vehicle, such as an airplane, an automobile, or a train, a facility, such as a tank, a pipeline, a cable, or a generator, or a device or a part forming these subjects.

As shown in FIGS. 1 and 2, observation system 300 includes observation device 100 and imaging device 200. In the following, these devices will be described.

[1-2. Imaging Device]

Imaging device 200 is a digital video camera or a digital still camera that includes an image sensor, for example. Imaging device 200 takes a video of subject 1. For example, imaging device 200 takes a video of subject 1 in a period including a time while an certain external load is being applied to subject 1. Note that although Embodiment 1 will be described with regard to an example in which an certain external load is applied, it is not necessarily supposed that there is an external load, and only the self-weight of subject 1 may be applied as a load, for example. Imaging device 200 may be a monochrome type or a color type.

Here, the certain external load may be a load caused by a moving body, such as a vehicle or a train, passing by, a wind pressure, a sound generated by a sound source, or a vibration generated by a device, such as a vibration generator, for example. The terms “certain” and “predetermined” can mean not only a fixed magnitude or a fixed direction but also a varying magnitude or a varying direction. That is, the magnitude or direction of the external load applied to subject 1 may be fixed or vary. For example, when the certain external load is a load caused by a moving body passing by, the load applied to subject 1 being imaged by imaging device 200 rapidly increases when the moving body is approaching, is at the maximum while the moving body is passing by, and rapidly decreases immediately after the vehicle has passed by. That is, the certain external load applied to subject 1 may vary while subject 1 is being imaged. When the certain external load is a vibration generated by equipment, such as a vibration generator, for example, the vibration applied to subject 1 imaged by imaging device 200 may be a vibration having a fixed magnitude and an amplitude in a fixed direction or a vibration that varies in magnitude or direction with time. That is, the certain external load applied to subject 1 may be fixed or vary while subject 1 is being imaged.

Note that although FIG. 1 shows an example in which observation system 300 includes one imaging device 200, observation system 300 may include two or more imaging devices 200. For example, two or more imaging devices 200 may be arranged in series along subject 1. In that case, each of two or more imaging devices 200 takes a video of subject 1. This allows subject 1 to be imaged at once even when subject 1 does not fit in one image, for example, so that the workability is improved. Two or more imaging devices 200 may be arranged on the opposite sides of subject 1. In that case, each of two or more imaging devices 200 takes an image of a different part or surface of subject 1 from a different direction. Since two or more imaging devices 200 can take images of different parts or surfaces of subject 1 from different directions at the same time, for example, the workability is improved. In addition, a behavior of subject 1 that cannot be observed by imaging in one direction can be advantageously observed. When observation system 300 includes two or more imaging devices 200, these imaging devices 200 may asynchronously or synchronously perform imaging. In particular, when the imaging is synchronously performed, the images at the same point in time taken by two or more imaging devices 200 can be compared or analyzed.

Note that although FIG. 1 shows an example in which imaging device 200 is an imaging device capable of taking a video in only one direction, imaging device 200 may be an imaging device capable of taking a video in a plurality of directions or an imaging device capable of omnidirectional imaging. In that case, for example, one imaging device 200 can take videos of a plurality of parts of subject 1 at the same time.

Imaging device 200 is not limited to the examples described above and may be a range finder camera, a stereo camera, or a time-of-flight (TOF) camera, for example. In that case, observation device 100 can detect a three-dimensional movement of subject 1 and therefore can detect a part having a defect with higher precision.

[1-3. Configuration of Observation Device]

Observation device 100 is a device that sets a plurality of observation points that are more than the points designated in the taken video of subject 1 and observes a movement of each of the plurality of observation points. Observation device 100 is a computer, for example, and includes a processor (not shown) and a memory (not shown) that stores a software program or an instruction. Observation device 100 implements a plurality of functions described later by the processor executing the software program. Alternatively, observation device 100 may be formed by a dedicated electronic circuit (not shown). In that case, the plurality of functions described later may be implemented by separate electronic circuits or by one integrated electronic circuit.

As shown in FIGS. 1 and 2, observation device 100 is connected to imaging device 200 in a communicable manner, for example. The scheme of communication between observation device 100 and imaging device 200 may be wireless communication, such as Bluetooth (registered trademark), or wired communication, such as Ethernet (registered trademark). Observation device 100 and imaging device 200 need not be connected in a communicable manner. For example, observation device 100 may obtain a plurality of videos from imaging device 200 via a removable memory, such as a universal serial bus (USB) memory.

As shown in FIG. 2, observation device 100 includes obtainer 10 that obtains a taken video of subject 1 from imaging device 200, display 20 that displays the obtained video, receiver 40 that receives a designation of at least one point in the video displayed on display 20, setting unit 60 that determines an area or an edge in the video based on the designated at least one point and sets a plurality of observation points in the determined area or on the determined edge, and observer 80 that observes a movement of each of the plurality of observation points in the video.

Obtainer 10 obtains a video of subject 1 transmitted from imaging device 200, and outputs the obtained video to display 20.

Display 20 obtains the video output from obtainer 10, and displays the obtained video. Display 20 may further display various kinds of information that are to be presented to a user in response to an instruction from controller 30. Display 20 is formed by a liquid crystal display or an organic electroluminescence (organic EL) display, for example, and displays image and textual information.

Receiver 40 receives an operation of a user, and outputs an operation signal indicative of the operation of the user to setting unit 60. For example, when a user designates at least one point in a video of subject 1 displayed on display 20, receiver 40 outputs information on the at least one point designated by the user to setting unit 60. Receiver 40 is a keyboard, a mouse, a touch panel, or a microphone, for example. Receiver 40 may be arranged on display 20, and is implemented as a touch panel, for example. For example, receiver 40 detects a position on a touch panel where a finger of a user touches the touch panel, and outputs positional information to setting unit 60. More specifically, when a finger of a user touches an area of a button, a bar, or a keyboard displayed on display 20, the touch panel detects the position of the finger touching the touch panel, and receiver 40 outputs an operation signal indicative of the operation of the user to setting unit 60. The touch panel may be a capacitive touch panel or a pressure-sensitive touch panel. Receiver 40 need not be arranged on display 20, and is implemented as a mouse, for example. Receiver 40 may detect the position of the area of display 20 selected by the cursor of the mouse, and output an operation signal indicative of the operation of the user to setting unit 60.

Setting unit 60 obtains an operation signal indicative of an operation of a user output from receiver 40, and sets a plurality of observation points in the video based on the obtained operation signal. For example, setting unit 60 obtains information on at least one point output from receiver 40, determines an area or an edge in the video based on the obtained information, and sets a plurality of observation points in the determined area or on the determined edge. More specifically, when setting unit 60 obtains information on at least one point output from receiver 40, setting unit 60 sets an observation area in the video based on the information. The observation area is an area determined in the video by the at least one point, and the plurality of observation points are set in the observation area. The set plurality of observation points may be more than the designated point(s). Once setting unit 60 sets a plurality of observation points in the observation area, setting unit 60 associates the information on the at least one point designated in the video by the user, information on the observation area, and information on the plurality of observation points with each other, and stores the associated information in a memory (not shown). A method of setting an observation area and a plurality of observation points will be described in detail later.

Observer 80 reads the information on the observation area and the plurality of observation points stored in the memory, and observes a movement of each of the plurality of observation points. Note that each of the plurality of observation points may be a point at the center or on the edge of an area corresponding to one pixel or a point at the center or on the edge of an area corresponding to a plurality of pixels. In the following, an area centered on an observation point will be referred to as an “observation block”. A movement (displacement) of each of the plurality of observation points is a spatial shift amount that indicates a direction of movement and a distance of movement, and is a movement vector that indicates a movement, for example. Here, the distance of movement is not the distance subject 1 has actually moved but is a value corresponding to the distance subject 1 has actually moved. For example, the distance of movement is the number of pixels in each observation block corresponding to the actual distance of movement. As a movement of each observation block, observer 80 may derive a movement vector of the observation block, for example. In that case, observer 80 derives a movement vector of each observation block by estimating the movement of the observation block using the block matching method, for example. A method of observing a movement of each of a plurality of observation points will be described in detail later.

Note that the method of deriving a movement of each of a plurality of observation points is not limited to the block matching method, and a correlation method, such as the normalized cross correlation method or the phase correlation method, the sampling moire method, the feature point extraction method (such as edge extraction), or the laser speckle correlation method can also be used, for example.

Note that observation device 100 may associate information on each of the plurality of observation points and information based on a result of observation of a movement of each of the plurality of observation points with each other, and store the associated information in the memory (not shown). In that case, the user of observation device 100 can read information based on a result of observation from the memory (not shown) at a desired timing. In that case, observation device 100 may display the information based on the result of observation on display 20 in response to an operation of the user received by receiver 40.

Note that the receiver and the display may be included in a device other than observation device 100, for example. Furthermore, although observation device 100 has been described as a computer as an example, observation device 100 may be provided on a server connected over a communication network, such as the Internet.

[1-4. Operation of Observation Device]

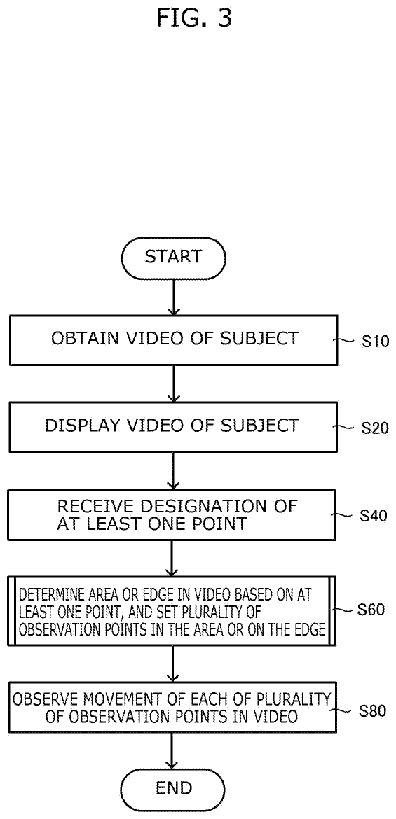

Next, an example of an operation of observation device 100 according to Embodiment 1 will be described with reference to FIG. 3. FIG. 3 is a flowchart showing an example of an operation of observation device 100 according to Embodiment 1. Note that an operation of the observation system according to Embodiment 1 includes an imaging step of imaging device 200 taking a video of subject 1 before obtaining step S10 shown in FIG. 3. In the imaging step, imaging device 200 takes a video of subject 1 when the external load applied to subject 1 is varying, for example. Therefore, observer 80 can derive differences in position between the plurality of observation points before the external load is applied to subject 1 and the plurality of observation points while the external load is being applied to subject 1, for example, based on the video obtained by obtainer 10.

As shown in FIG. 3, obtainer 10 obtains a taken video of subject 1 (obtaining step S10). Observation device 100 may obtain images one by one or images taken in a predetermined period from imaging device 200. Note that observation device 100 may obtain one or more taken images of subject 1 from imaging device 200 after the imaging of subject 1 by imaging device 200 is ended. The method in which obtainer 10 obtains a video (or image) is not particularly limited. As described above, obtainer 10 may obtain a video by wireless communication or may obtain a video via a removable memory, such as an USB memory.

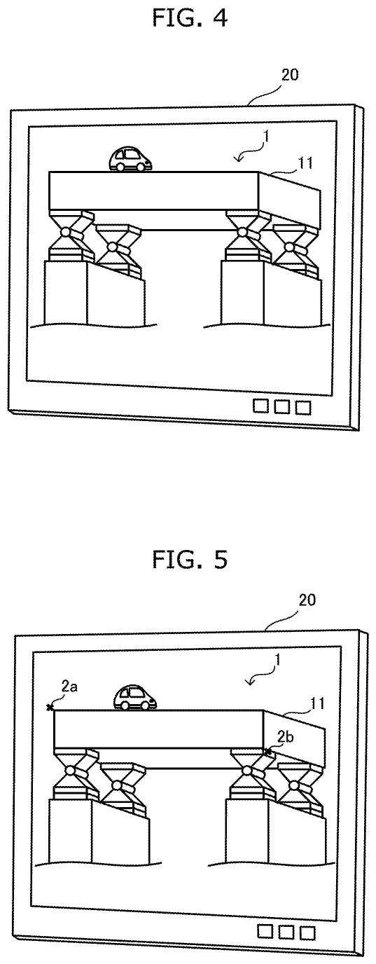

Display 20 then displays the video of subject 1 obtained by obtainer 10 in obtaining step S10 (display step S20). FIG. 4 is a diagram showing an example of the video of subject 1 displayed on display 20. As shown in FIG. 4, subject 1 is a bridge, for example.

Receiver 40 then receives a designation of at least one point in the video displayed on display 20 in display step S20 (receiving step S40). Receiver 40 outputs information on the at least one designated point to setting unit 60. More specifically, once the user designates at least one point in the video displayed on display 20, receiver 40 outputs information on the at least one point designated by the user to setting unit 60. FIG. 5 is a diagram showing an example of the at least one point designated in the video of subject 1 displayed on display 20. As shown in FIG. 5, once two points 2a and 2b are designated in the video of subject 1, receiver 40 outputs information on the positions or the like of point 2a and point 2b to setting unit 60.

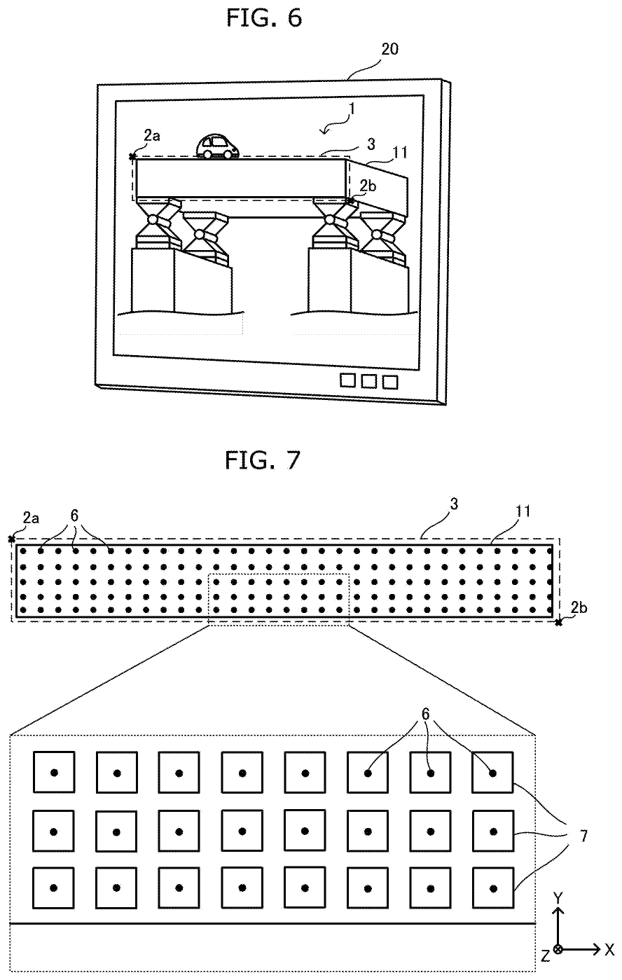

Setting unit 60 then determines an area or an edge in the video of subject 1 based on the at least one designated point (point 2a and point 2b in this example), and sets a plurality of observation points in the determined area or on the determined edge (setting step S60). In the following, a method of setting a plurality of observation points will be more specifically described with reference to FIGS. 6 and 7. FIG. 6 is a diagram showing an example of an observation area set based on the at least one point designated in the video by the user. As shown in FIG. 6, setting unit 60 sets observation area 3 in the video based on user operation information (information on the positions or the like of point 2a and point 2b, which are the two points designated by the user, in this example) received by receiver 40 in receiving step S40. More specifically, setting unit 60 obtains information on two points 2a and 2b designated by the user, and sets a quadrilateral area having point 2a and point 2b as diagonal vertices thereof based on the obtained information.

Observation area 3 is an area determined in the video based on the at least one point, and a plurality of observation points 6 in FIG. 7 is set in observation area 3. Observation area 3 may be a quadrilateral area having a vertex in the vicinity of the at least one point or a round or quadrilateral area centered in the vicinity of the at least one point. The term “vicinity” means “within a predetermined range”, such as within 10 pixels. Note that the predetermined range is not limited to this range, and can be appropriately set depending on the imaging magnification of the video of subject 1. The round shape can be any substantially round shape and may be a circular shape or an elliptical shape, for example. Note that observation area 3 is not limited to the shapes described above, and may have any polygonal shape, such as a triangular shape, a rectangular shape, a pentagonal shape, or a hexagonal shape.

FIG. 7 is an enlarged view of observation area 3 shown in FIG. 6. As shown in FIG. 7, setting unit 60 sets a plurality of observation points 6 in observation area 3. More specifically, setting unit 60 reads a correspondence table (not shown) that associates the size of observation area 3, that is, the number of pixels of observation area 3 in the video, and data such as the number of observation points 6 that can be set in observation area 3 or the distance between observation points 6 from the memory (not shown), and sets the plurality of observation points 6 in observation area 3 based on the read correspondence table.

FIG. 7 also shows an enlarged view of a part of observation area 3 enclosed by a dotted line. Each of the plurality of observation points 6 is a center point of observation block 7, for example. Observation block 7 may be an area corresponding to one pixel or an area corresponding to a plurality of pixels. Observation block 7 is set based on the correspondence table.

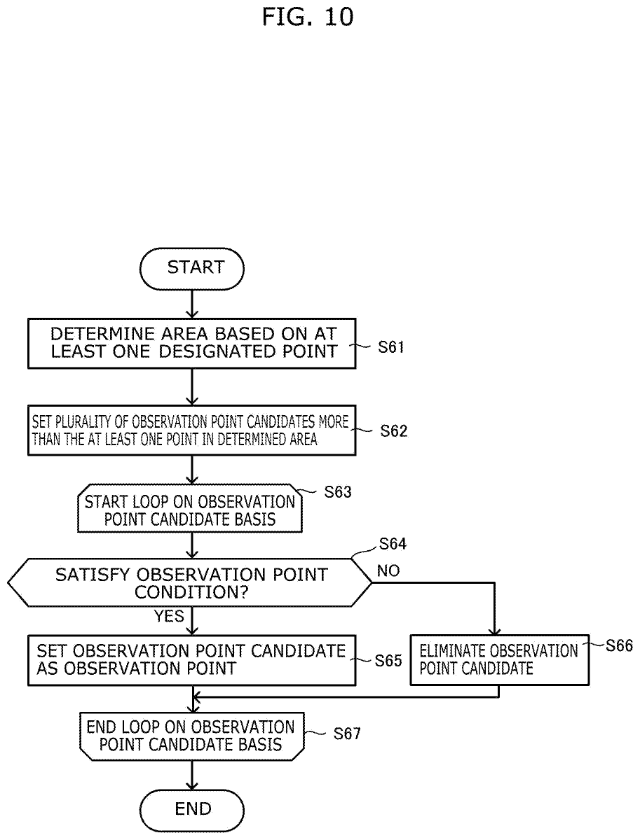

Setting unit 60 associates the information on the at least one point (point 2a and point 2b in this example) designated by the user, information on observation area 3, and information on the plurality of observation points 6 and a plurality of observation blocks 7 with each other, and stores the associated information in the memory (not shown). Note that a detailed process flow of setting step S60 will be described later with reference to FIG. 10.

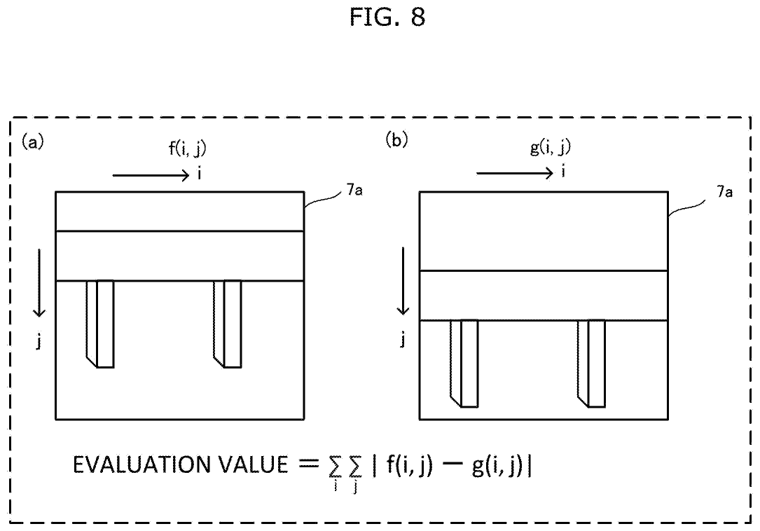

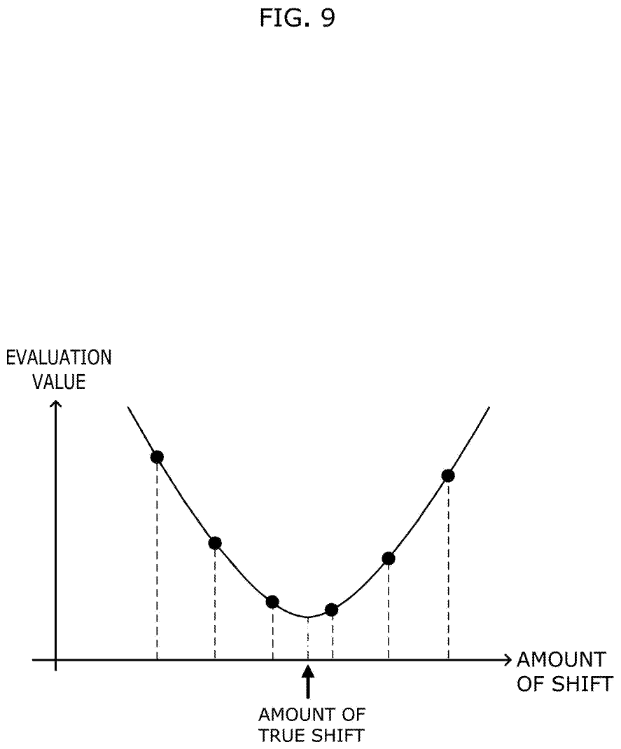

Observer 80 then observes a movement of each of the plurality of observation points in the video (observation step S80). As described above, observation point 6 is a center point of observation block 7, for example. The movement of each of the plurality of observation points 6 is derived by calculating the amount of shift of the image between a plurality of observation blocks 7 in the block matching method, for example. That is, the movement of each of the plurality of observation points 6 corresponds to the movement of observation block 7 having the observation point 6 as the center point thereof. Note that a shift (that is, movement) of the image in observation block 7a between frames F and G in FIG. 8 indicates the displacement of subject 1 in observation block 7a. In the following, an operation of observer 80 will be more specifically described with reference to FIGS. 8 and 9. FIG. 8 is a diagram for illustrating an example of the calculation of a movement of observation block 7a between two consecutive frames F and G. Part (a) of FIG. 8 is a diagram showing an example of observation block 7a in frame F in the video, and part (b) of FIG. 8 is a diagram showing an example of observation block 7a in frame G subsequent to frame F. The formula shown in FIG. 8 is a formula for calculating an absolute value of the amount of shift between observation block 7a in frame F and observation block 7a in frame G (referred to simply as “amount of shift”, hereinafter) as an evaluation value. For example, as shown in FIG. 8, observer 80 selects two consecutive frames F and G in the video, and calculates an evaluation value of the amount of shift of observation block 7a between frames F and G. The amount of shift at the time when the evaluation value is at the minimum corresponds to the amount of true shift on a pixel basis between two frames F and G.

FIG. 9 is a diagram showing an example of an approximation curve for the evaluation value calculated according to the formula shown in FIG. 8. A black dot in FIG. 9 schematically indicates an evaluation value on an integral pixel basis. As shown in FIG. 9, observer 80 may create an approximation curve for the calculated evaluation value, and derive, as the amount of true shift, the amount of shift at the time when the evaluation value is at the minimum on the approximation curve. In this way, the amount of true shift can be derived on a finer unit (sub-pixel) basis.

In the following, setting step S60 will be more specifically described with reference to FIGS. 10 to 12. FIG. 10 is a flowchart showing an example of a detailed process flow of setting step S60. FIG. 10 shows a process flow after the information on the at least one point output from receiver 40 is obtained.

As shown in FIG. 10, setting unit 60 determines an area based on the at least one point designated by the user (step S61). More specifically, as shown in FIG. 11, setting unit 60 determines a quadrilateral area having point 2a and point 2b designated by the user as diagonal vertices thereof. For example, setting unit 60 determines a quadrilateral area defined by four sides each extending from point 2a or point 2b in the horizontal direction or vertical direction of the display region of display 20. The area determined in this way is referred to as observation area 3 (see FIG. 6).

FIG. 11 is a diagram showing an example of the setting of a plurality of observation point candidates 4 in observation area 3. Setting unit 60 sets a plurality of observation point candidates 4 that are more than the at least one point (point 2a and point 2b in this example) in observation area 3 determined in step S61 (step S62).

Setting unit 60 then starts a processing loop for an observation point candidate 4 basis for the plurality of observation point candidates 4 set in step S62 (step S63), determines whether each observation point candidate 4 satisfies an observation point condition (step S64), and performs a processing of setting any observation point candidate 4 of the plurality of observation point candidates 4 that satisfies the observation point condition as observation point 6. After the processing loop for an observation point candidate 4 basis is performed for all of the plurality of observation point candidates 4, the processing loop for an observation point candidate 4 basis is ended (step S67). The processing loop for an observation point candidate 4 basis will be more specifically described. Setting unit 60 selects observation point candidate 4 from among the plurality of observation point candidates 4, and determines whether the observation point candidate 4 satisfies the observation point condition or not. When setting unit 60 determines that the observation point candidate 4 satisfies the observation point condition (if YES in step S64), setting unit 60 sets the observation point candidate 4 as observation point 6 (see FIG. 7) (step S65). In this case, for example, setting unit 60 flags the observation point 6 and stores the flagged observation point 6 in the memory (not shown). Note that the memory (not shown) may be included in observation device 100 as a component separate from setting unit 60.

On the other hand, when setting unit 60 selects observation point candidate 4 from among the plurality of observation point candidates 4 set in step S62, and determines that the observation point candidate 4 does not satisfy the observation point condition (if NO in step S63), setting unit 60 eliminates the observation point candidate 4 (step S66). In this case, for example, setting unit 60 stores a determination result that the observation point candidate 4 does not satisfy the observation point condition in the memory (not shown).

When setting unit 60 determines whether observation point candidate 4 satisfies the observation point condition or not in step S64, setting unit 60 evaluates an image of an observation block candidate having the observation point candidate 4 as the center point thereof (referred to as an observation block candidate, hereinafter), or compares an image of an observation block candidate and an image of each of a plurality of observation block candidates in the vicinity of the observation block candidate (referred to as a plurality of other observation block candidates, hereinafter). In this step, setting unit 60 compares these images in terms of a characteristic of the images, such as signal level, frequency characteristic, contrast, noise, edge component, and color.

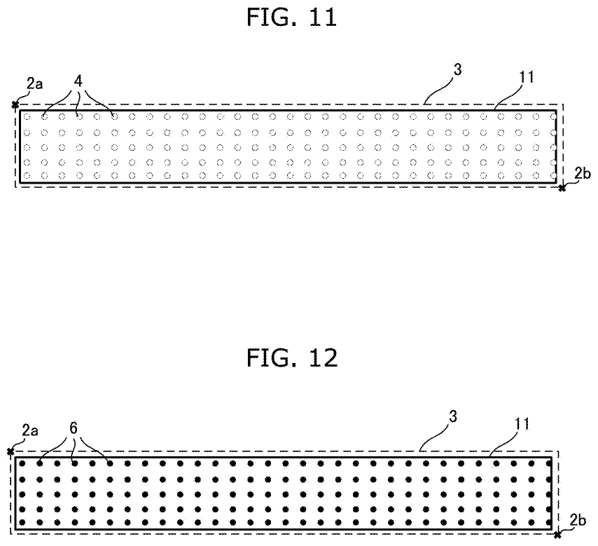

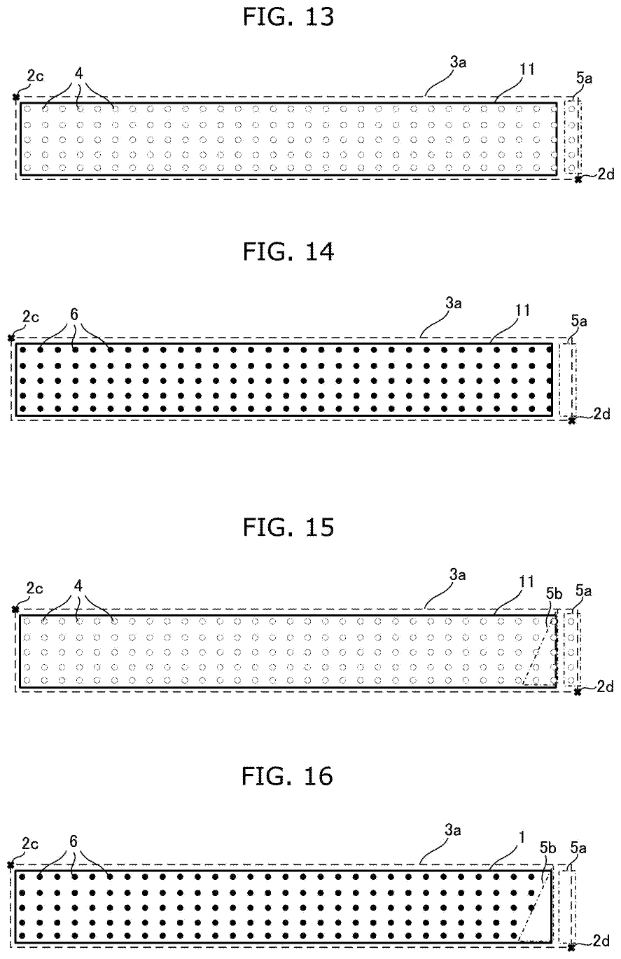

In this way, setting unit 60 set a plurality of observation points 6 by performing the determination of whether the observation point candidate satisfies the observation point condition or not (step S64) for all of the plurality of observation point candidates 4. FIG. 12 is a diagram showing an example in which all of the plurality of observation point candidates 4 shown in FIG. 11 are set as observation point 6. As shown in FIG. 12, when all of the plurality of observation point candidates 4 shown in FIG. 11 satisfy the observation point condition, all observation point candidates 4 in observation area 3 are set as observation point 6. Note that a case where the plurality of observation point candidates 4 set in observation area 3 include observation point candidate 4 that does not satisfy the observation point condition will be described later with reference to FIGS. 13 to 16.

The observation point condition is a condition for determining an area that is suitable for observation of a movement of subject 1, and there are three observation point conditions described below. Observation point condition (1) is that subject 1 is present in a target area in which an observation point is to be set. Observation point condition (2) is that the image quality of a target area in which an observation point is to be set is good. Observation point condition (3) is that there is no foreign matter that can hinder observation in a target area in which an observation point is to be set. Therefore, “observation point candidate 4 that satisfies the observation point condition” means observation point candidate 4 set in an area that satisfies all of these tree conditions.

Note that “subject 1 is present in a target area” means that an image of subject 1 is included in the target area and, for example, means that an image of a background of subject 1, such as sky or cloud, is not included in the target area, or an image of an object other than subject 1 is not included in the foreground or background of subject 1.

The presence of subject 1 can be discriminated by evaluating an image of an observation block candidate and checking that a first predetermined condition for the observation block candidate is satisfied. For example, the first predetermined conditions are that [1] an average, a variance, a standard deviation, a maximum, a minimum, or a median of signal levels of an image falls within a preset range, [2] a frequency characteristic of an image falls within a preset range, [3] a contrast of an image falls within a preset range, [4] an average, a variance, a standard deviation, a maximum, a minimum, a median, or a frequency characteristic of noise of an image falls within a preset range, [5] an average, a variance, a standard deviation, a maximum, a minimum, or a median of a color or color signal of an image falls within a preset range, and [6] a proportion, an amount, or an intensity of edge components in an image falls within a preset range.

Although according to first predetermined conditions [1] to [6], the presence or absence of subject 1 is discriminated based on whether a characteristic of an image in an observation block candidate falls within a preset range or not, the present disclosure is not limited thereto. For example, a plurality of observation block candidates may be grouped based on a statistical value, such as average or variance, of the result of evaluation of a characteristic of an image listed in first predetermined conditions [1] to [6] or a similarity thereof, and the presence or absence of subject 1 may be discriminated for each of the resulting groups. For example, of the resulting groups, subject 1 may be determined to be present in the group formed by the largest number of observation block candidates or in the group formed by the smallest number of observation block candidates. Note that subject 1 may be determined to be present in a plurality of groups, rather than in one group, such as the group formed by the largest or smallest number of observation block candidates. The plurality of observation block candidates may be grouped by considering the positional relationship between the observation block candidates. For example, of the plurality of observation block candidates, observation block candidates closer to each other in the image may be more likely to be sorted into the same group. By grouping a plurality of observation block candidates by considering the positional relationship between the observation block candidates in this way, the precision of the determination of whether subject 1 is present in the target area is improved. The region in which subject 1 is present is often one continuous region. Therefore, when the observation block candidate(s) determined not to include subject 1 in the method described above is an isolated observation block candidate surrounded by a plurality of observation block candidates determined to include subject 1 or are a small number of observation block candidates surrounded by a plurality of observation block candidates determined to include subject 1, the observation block candidate(s) determined not to include subject 1 may be re-determined to include subject 1. In this way, the occurrence of erroneous determination can be reduced when determining the presence or absence of subject 1.

Note that “the image quality of the target area is good” means a state where the amount of light incident on imaging device 200 is appropriate and an object in the image can be recognized, for example. “The image quality of the target area is not good” means a state where an object in the image is difficult to recognize, and applies to a high-luminance area (such as a blown-out highlight area) in which an average of the luminance of the target area is higher than an upper limit threshold or a low-luminance area (such as a blocked-up shadow area) in which an average of the luminance of the target area is lower than a lower limit threshold, for example. Furthermore, “the image quality of the target area is not good” also means a state where the image is blurred because of blurred focus or lens ablation, a state where the image is deformed or blurred because of atmospheric fluctuations, or a state where a fluctuation of the image is caused by a motion of imaging device 200 caused by vibrations from the ground or by wind.

It can be determined that the image quality of the target area is good by evaluating an image of an observation block candidate and checking that a second predetermined condition for the observation block candidate is satisfied. For example, the second predetermined conditions are that [7] a signal level of an image falls within a preset range (for example, a signal level is not so high that the blown-out highlights described above occur or is not so low that the blocked-up shadows occur), [8] an average, a variance, a standard deviation, a maximum, a minimum, or a median of signal levels of an image falls within a preset range, [9] a frequency characteristic of an image falls within a preset range, [10] a contrast of an image falls within a preset range, [11] an average, a variance, a standard deviation, a maximum, a minimum, or a median of noise of an image, a frequency characteristic of noise, or a signal to noise ratio (SNR) of an image falls within a preset range, [12] an average, a variance, a standard deviation, a maximum, a minimum, or a median of a color or color signal of an image falls within a preset range, [13] a proportion, an amount, an intensity, or a direction of edge components in an image falls within a preset range, and [14] a temporal variation of a characteristic in an image listed in [1] to [13] falls within a preset range.

The deformation, blurring, or fluctuation of the image caused by atmospheric fluctuations or a motion of imaging device 200 described above often occurs in the form of a temporal variation of the image. Therefore, it can be determined that these phenomena have not occurred and the image quality of the target area is good by evaluating an image of an observation block candidate and checking that a third predetermined condition for the same observation block candidate is satisfied. For example, the third predetermined conditions are that [15] a temporal deformation (an amount of deformation, a rate of deformation, or a direction of deformation), an amount of enlargement, an amount of size reduction, a change of area (an amount of change or a rate of change) of an image, or an average or variance thereof falls within a preset range, [16] a temporal deformation or bending of an edge in an image falls within a preset range, [17] a temporal variation of an edge width in an image falls within a preset range, [18] a temporal variation of a frequency characteristic of an image falls within a preset range, and [19] a ratio of a movement or displacement in an image of subject 1 including direction detected in the image to a possible movement in the image falls within a preset range.

The deformation or blurring of an image because of atmospheric fluctuations described above is often a variation that occurs in a plurality of observation block candidates. Therefore, it can be determined that these variations have not occurred and the image quality of the target area is good by checking that, in images of a plurality of observation block candidates, a fourth predetermined condition for adjacent observation block candidates of the plurality of observation block candidates is satisfied. For example, the fourth predetermined condition is that [20] a difference in deformation, amount of enlargement, amount of size reduction, or change of area of the images, deformation or bending of an edge in the images, variation of an edge width in the images, variation of a frequency characteristic of the images, ratio of a movement or displacement in an image of subject 1 including direction detected in the image to a possible movement in the image, or average or variance thereof falls within a preset range. When the atmospheric fluctuations described above occur, it is difficult to precisely observe or measure a movement of subject 1. When such a phenomenon that hinders observation of a movement of subject 1 occurs, observation device 100 may notify the user of this situation where a movement of subject 1 cannot be precisely observed. The user may be notified by means of an image or a sound, for example. In this way, the user can observe a movement of subject 1 by avoiding a situation that is not suitable for observation of a movement of subject 1. More specifically, when it is determined that the image quality is not good based on the predetermined conditions [15] to [20] described above, setting unit 60 determines that there is a high possibility that an atmospheric fluctuation is occurring and causing the degradation of the image quality. In that case, observation device 100 may display the determination result and the determined cause on display 20 or produce an alarm sound or a predetermined sound from a speaker (not shown). Furthermore, setting unit 60 associates the determination result that there is a high possibility that an atmospheric fluctuation is occurring and the determination result that all the observation point candidates do not satisfy the observation point condition with each other, and stores the associated determination results in the memory (not shown). When it is determined that an atmospheric fluctuation is occurring, means (not shown) for controlling imaging device 200 to take an image by raising the imaging period (frame rate) of imaging device 200 may be provided so that the influence of the atmospheric fluctuation on the observation result of the movement of subject 1 can be reduced.

Note that the foreign matter that can hinder observation is a moving body other than subject 1 or a deposit adhering to subject 1, for example. The moving body is not particularly limited and can be any moving body other than subject 1. For example, the moving body is a vehicle, such as an airplane, a train, an automobile, a motorcycle, or a bicycle, an unattended flying object, such as a radio-controlled helicopter or a drone, a living thing, such as an animal, a human being, or an insect, or play equipment, such as a ball, a swing, or a boomerang. The deposit is a sheet of paper, such as a poster, a nameplate, a sticker, or dust, for example.

If a moving body passes by over an observation point set in a video, the movement of the observation point is different from the movement of subject 1. That is, the movement of the observation point observed by observation device 100 does not correspond to the movement of subject 1. When an observation point is set on a deposit in a video, if the surface of the deposit has no texture, or the deposit moves because of wind or a motion of subject 1, for example, it is difficult to precisely observe a movement of subject 1. Therefore, setting unit 60 eliminates any area that does not satisfy observation point condition (3), that is, any area that includes a video of a foreign matter that can hinder observation, such as those described above, from observation areas 3 as an area that does not satisfy an observation point condition (an inappropriate area). In this way, any observation point candidate 4 that is set in an inappropriate area can be eliminated from the observation point candidates. For example, when a moving body is detected in a video, setting unit 60 eliminates the moving body from observation targets. In other words, setting unit 60 eliminates the area in the video in which the moving body overlaps with subject 1 from observation areas 3 as an inappropriate area. Furthermore, when a deposit is detected on subject 1 in a video, setting unit 60 eliminates the area where the deposit overlaps with subject 1 from observation areas 3 as an inappropriate area.

Note that, as a method of determining a foreign matter that can hinder observation, there is a method of determining that an observation block candidate includes a foreign matter that can hinder observation when the observation block candidate does not satisfy condition [14] and any of conditions [15] to [19] described above, for example. Furthermore, for example, [21] there is a method in which a displacement of an image of each of a plurality of observation block candidates is observed, and of the plurality of observation block candidates, if there is an isolated observation block candidate in which a greater image displacement is observed than in the other observation block candidates or there are a small number of adjacent observation block candidates in which a greater image displacement is observed than in the other observation block candidates, or if there is an isolated observation block candidate in which an image displacement equal to or greater than an average of the image displacements of the plurality of observation block candidates is observed or there are a small number of adjacent observation block candidates in which an image displacement equal to or greater than an average of the image displacements of the plurality of observation block candidates is observed, the isolated observation block candidate or the small number of adjacent observation block candidates is/are determined to include a foreign matter that can hinder observation. Furthermore, [22] there is a method of evaluating a temporal variation of the evaluation value described above with reference to FIG. 9. For example, if there is no foreign matter in a target area in which an observation point is to be set, the temporal variation of the evaluation value determined from the image of the observation block candidate is small, because the variation or deformation of the image is small. However, if there is a foreign matter in a target area, the temporal variation of the evaluation value determined from the image of the observation block candidate is greater than when there is no foreign matter in the target area, because the variation or deformation of the image is great. Therefore, if the evaluation value determined from the image of the observation block candidate more greatly varies with time than a preset value, it is determined that there is a foreign matter that can hinder observation in the target area. [23] As far as the foreign matter is not so large as to cover the whole of the taken video, the variation of the evaluation value described above occurs in the limited observation block candidates in which the foreign matter is present, and therefore, the evaluation value of each observation block candidate can be compared with the evaluation value of a peripheral observation block candidate in the vicinity of the observation block candidate, and it can be determined that the foreign matter that can hinder observation is present in the target area if the difference between the evaluation values is greater than a preset value. Note that there is an adequate possibility that a moving foreign matter, such as a moving body, occurs in a video not only in a period in which an observation block candidate that satisfies an observation point condition is selected from among a plurality of observation block candidates but also at other timings. For example, a moving body may pass by over an observation block in a video during measurement of a movement of subject 1. In that case, the moving body can be detected in the video in the method described above, and information that the moving body has passed by over the observation block can be stored in the memory (not shown). In the observation block by which the moving body passes, a movement of subject 1 cannot be precisely observed at least while the moving body is passing by. Therefore, the movement of subject 1 in the observation block in the period in which the movement of subject 1 cannot be precisely observed may be interpolated with the observation result of the movement of subject 1 in another observation block in the vicinity of the observation block. More specifically, observation device 100 may store an average of movements of subject 1 in other observation blocks in the vicinity of the observation block in the memory (not shown) as an observation result of the movement of subject 1 in the observation block. Observation device 100 may also read information stored in the memory (not shown), such as information that a moving body passed by over the observation block in the video, from the memory (not shown), and interpolate the movement of subject 1 in the period in which the moving body was passing by over the observation block with the observation result of the movement of subject 1 in another observation block in the vicinity of the observation block after the observation of the movement of subject 1 is ended.

Note that an example has been described in which values of the predetermined conditions described in [1] to [23] are set in advance, the values may be set as required depending on the video used for the observation of the movement of subject 1.

As a method of determining whether an observation block candidate satisfies each of observation point conditions (1) to (3) or not, a method based on predetermined conditions described in [1] to [23] described above has been described. However, the present disclosure is not limited thereto. The methods that can be used for determining whether an observation block candidate satisfies each observation point condition or not are not necessarily classified according to the observation point conditions described above. For example, the determination method described with regard to observation point condition (1) may be used for the determination of whether or not the observation block candidate satisfies observation point condition (2) or observation point condition (3), or the determination method described with regard to observation point condition (2) or observation point condition (3) may be used for the determination of whether the observation block candidate satisfies observation point condition (1) or not.

In the following, cases where the observation point candidates set in an observation area include any observation point candidate that does not satisfy an observation point condition will be specifically described with reference to the drawings.

FIG. 13 is a diagram showing an example in which a plurality of observation point candidates 4 set in observation area 3a include observation point candidates 4 that do not satisfy an observation point condition. FIG. 14 is a diagram showing an example in which a plurality of observation points 6 are set by eliminating, from the observation point candidates, observation point candidates 4 that do not satisfy an observation point condition of the plurality of observation point candidates 4. As shown in FIGS. 13 and 14, observation area 3a is a quadrilateral area having point 2c and point 2d designated by a user as diagonal vertices thereof. As shown in FIG. 13, setting unit 60 sets a plurality of observation point candidates 4 in observation area 3a (step S62 in FIG. 10). Setting unit 60 determines any observation point candidate 4 that does not satisfy observation point condition (1) in the plurality of observation point candidates 4 set in step S62, and eliminates the observation point candidate from the observation point candidates (step S66 in FIG. 10). In other words, setting unit 60 determines an area (referred to as inappropriate area 5a, hereinafter) in which subject 1 is not present in observation area 3a, and eliminates any observation point candidate 4 set in inappropriate area 5a. As shown in FIG. 14, setting unit 60 determines whether observation point candidate 4 satisfies the observation point condition or not for all observation point candidates 4 set in observation area 3a shown in FIG. 13 (step S67 in FIG. 10), and then sets a plurality of observation points 6 in observation area 3a. In this way, even when set observation area 3a includes an area in which subject 1 is not present, setting unit 60 can appropriately set a plurality of observation points 6 by determining whether observation point candidates 4 are set in an area that satisfies the observation point condition.

FIG. 15 is a diagram showing another example in which a plurality of observation point candidates 4 set in observation area 3a include observation point candidates 4 that do not satisfy an observation point condition. FIG. 16 is a diagram showing another example in which a plurality of observation points 6 are set by eliminating, from the observation point candidates, observation point candidates 4 that do not satisfy an observation point condition of the plurality of observation point candidates 4. As shown in FIG. 15, setting unit 60 sets a plurality of observation point candidates 4 in observation area 3a (step S62 in FIG. 10). Setting unit 60 determines any observation point candidate 4 that does not satisfy any of observation point conditions (1) to (3) in the plurality of observation point candidates 4 set in step S62, and eliminates the observation point candidate from the observation point candidates (step S66 in FIG. 10). In this step, setting unit 60 determines an area (inappropriate area 5a described above) in which subject 1 is not present and an area (referred to as inappropriate area 5b, hereinafter) in which the image quality is not good in observation area 3a, and eliminates any observation point candidate 4 set in inappropriate area 5a and inappropriate area 5b. As shown in FIG. 16, setting unit 60 determines whether observation point candidate 4 satisfies the observation point conditions or not for all observation point candidates 4 set in observation area 3a shown in FIG. 15 (step S67 in FIG. 10), and then sets a plurality of observation points 6 in observation area 3a. In this way, even when set observation area 3a includes an area in which subject 1 is not present and an area in which the image quality is not good, setting unit 60 can appropriately set a plurality of observation points 6 by determining whether observation point candidates 4 are set in an area that satisfies the observation point conditions.

Although not shown, setting unit 60 may calculate a satisfying degree of each of the plurality of observation points 6, the satisfying degree indicating the degree to which the observation point satisfies an observation point condition, and display 20 may display the satisfying degree in the video of subject 1. The satisfying degree of each observation point 6 may be indicated by a numeric value, such as by percentage or on a scale of 1 to 5, or may be indicated by color coding based on the satisfying degree. Note that the satisfying degree is an index that indicates to what extent each set observation point 6 satisfies a condition set in the determination methods for the observation point conditions described above.

Note that an example has been described in which the observation area is a quadrilateral area having the two points designated in the video by the user as diagonal vertices thereof, the observation area is not limited to this example. For example, the observation area may be set based on at least one point designated in the video by the user as described below.

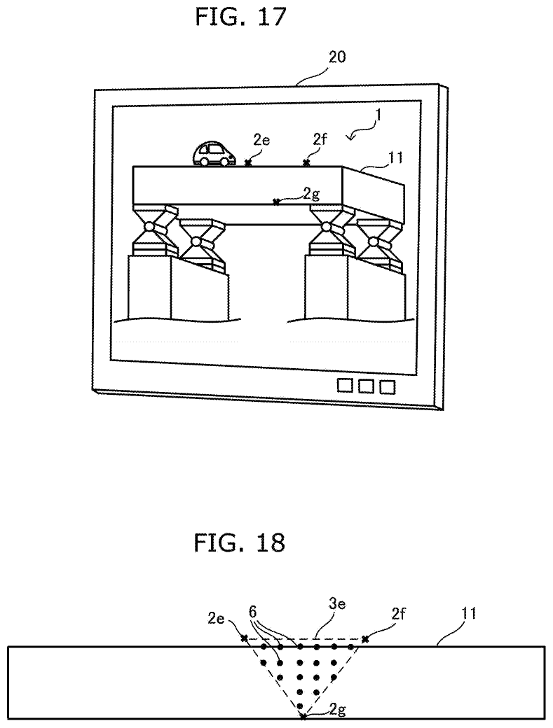

FIG. 17 is a diagram showing another example of the at least one point designated in the video of subject 1 displayed on display 20. FIG. 18 is a diagram showing another example of the observation area set based on the at least one point designated in the video by the user. As shown in FIG. 17, when three points, point 2e, point 2f, and point 2g (referred to as points 2e to 2g, hereinafter) are designated in the video of subject 1, receiver 40 outputs information on the positions or the like of points 2e to 2f to setting unit 60. As shown in FIG. 18, setting unit 60 then sets triangular observation area 3e having points 2e to 2f as the vertices thereof based on the information on designated points 2e to 2f, and sets a plurality of observation points 6 in set observation area 3e. Although FIG. 18 shows observation area 3e having three designated points as a triangular area, observation area 3e is not limited to this. For example, observation area 3e having four designated points, five designated points, six designated points, or n designated points may have a rectangular shape, a pentagonal shape, a hexagonal shape, or an n-sided polygonal shape.

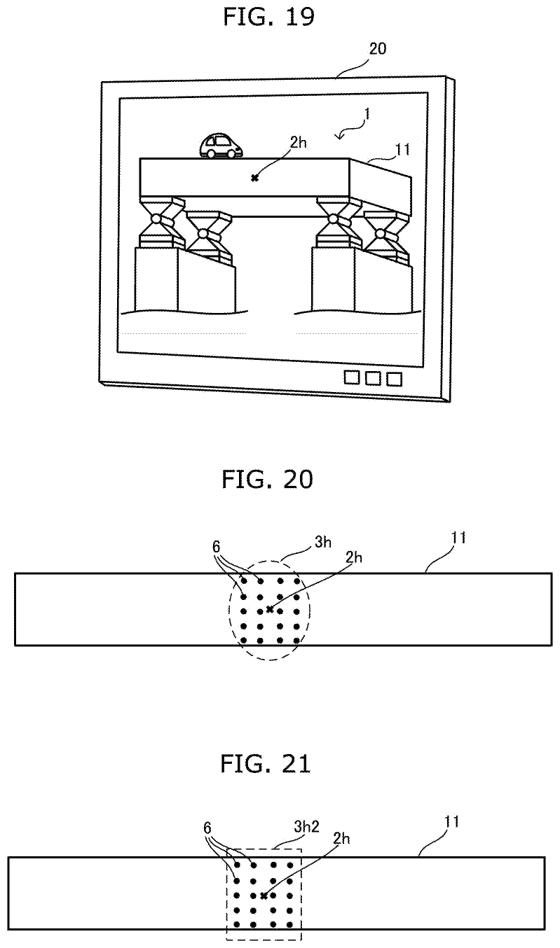

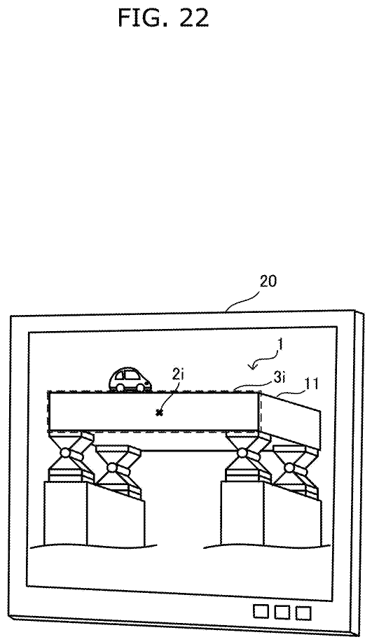

FIG. 19 is a diagram showing another example of the at least one point designated in the video of subject 1 displayed on display 20. FIG. 20, FIG. 21, and FIG. 22 are diagrams showing other examples of the observation area set based on the at least one point designated in the video by the user. As shown in FIG. 19, when point 2i is designated in the video of subject 1, receiver 40 outputs information on the position or the like of point 2i to setting unit 60. As shown in FIG. 20, setting unit 60 then sets round observation area 3h centered on point 2i based on the information on designated point 2i, and sets a plurality of observation points 6 in set observation area 3h. Although an example is shown here in which observation area 3h is a round area centered on point 2i, observation area 3h2 shown in FIG. 21, which is a quadrilateral area centered on point 2i, is also possible. Although FIG. 21 shows observation area 3h2 as a rectangular area, observation area 3h2 is not limited to this. For example, observation area 3h2 may have a triangular shape, a pentagonal shape, or a hexagonal shape. When the user designates point 2i on bridge beam 11 in the video as shown in FIG. 22, setting unit 60 sets an area identified as the same subject as bridge beam 11 as observation area 3i.

Setting unit 60 may set two or more observation areas based on information on a plurality of points designated in the video by the user.

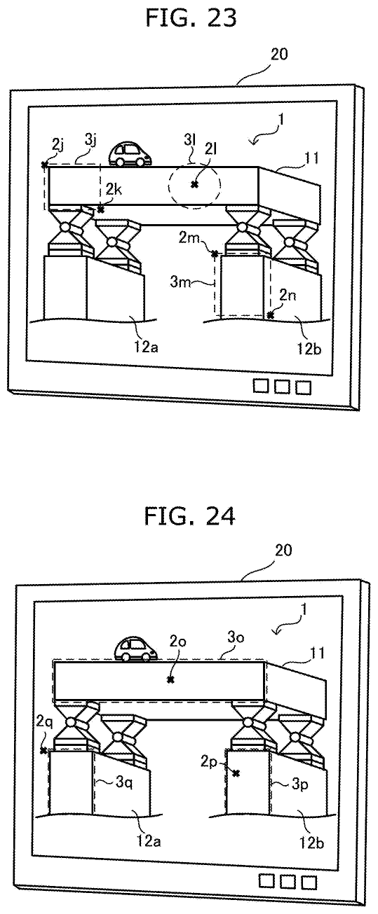

FIG. 23 is a diagram showing an example of a plurality of (three) observation areas set based on at least one point at a plurality of (three) positions designated in the video by the user. As shown in FIG. 23, for example, when the user designates point 2j and point 2k in the vicinity of bridge beam 11 in the video of subject 1, setting unit 60 sets a quadrilateral observation area 3j having point 2j and point 2k as diagonal vertices thereof. When the user then designates point 21 on bridge beam 11, setting unit 60 sets round observation area 31 centered on point 21. When point 2m and point 2n are then designated in the vicinity of bridge pier 12b, setting unit 60 sets quadrilateral observation area 3m having point 2m and point 2n as diagonal vertices thereof.

FIG. 24 is a diagram showing another example of a plurality of (three) observation areas set based on at least one point at a plurality of (three) positions designated in the video by the user. As shown in FIG. 24, for example, when the user designates point 2o on bridge beam 11 in the video of subject 1, setting unit 60 sets a partial area of the face including point 2o of bridge beam 11 that is identified as a part of subject 1 as observation area 3o. When the user then designates point 2p on bridge pier 12b, setting unit 60 sets a partial area of the face including point 2p of bridge pier 12b that is identified as a part of subject 1 as observation area 3p. When the user designates point 2q in the vicinity of bridge pier 12a, setting unit 60 sets an area closest to point 2q of a plurality of areas identified as a plurality of subjects (such as bridge beam 11 and a bearing) as observation area 3q. Setting unit 60 sets a plurality of observation points 6 in each of these observation areas according to the process flow described above.

Note that, as the method of identifying the face including point 2o or point 2p or the area close to point 2q, the technique of segmenting an image (the so-called image segmentation) using a feature of the image, such as brightness (luminance), color, texture, and edge, is known, and one face or a partial area of the subject in the image may be determined using this technique. If the range finder camera, the stereo camera, or the time-of-flight (TOF) camera described above is used, information (the so-called depth map) on the imaged subject in the depth direction can be obtained, and this information may be used to extract a part on the same face in the three-dimensional space from the image and determine one face of the subject in the image, or to determine one part of the subject in the image based on the positional relationship in the three-dimensional space, for example.

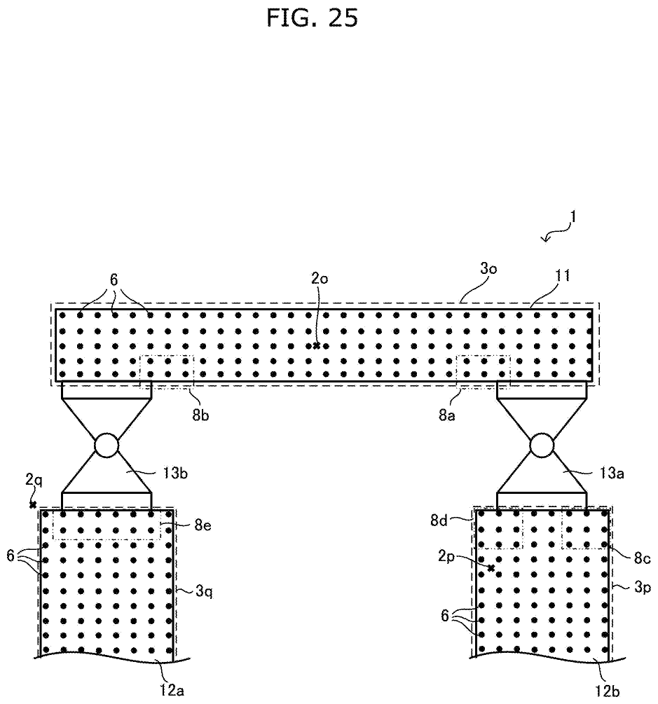

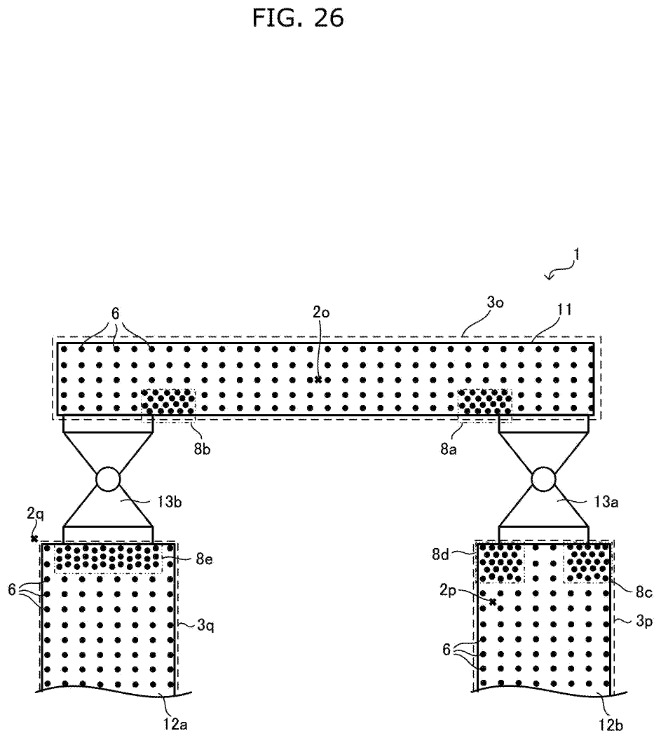

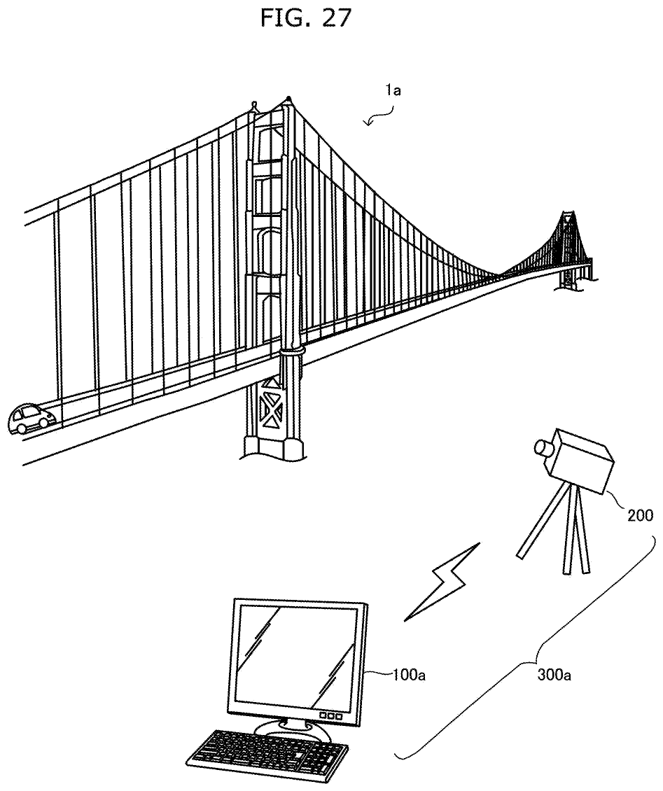

Observer 80 observes the movement of each of a plurality of observation points 6, and stores the observation result in the memory (not shown). Here, the movement of observation point 6 means the movement itself and a tendency of the movement. Here, when the plurality of observation points 6 include observation point 6 whose movement is different from those of the other observation points 6, observer 80 flags the observation point 6, and stores the results in the memory (not shown). Setting unit 60 reads the observation result from the memory (not shown), sets a re-set area including the observation point 6 whose movement is different from those of the other observation points 6, and re-sets a plurality of observation points 6 in the re-set area. FIG. 25 is a diagram showing an example of the setting of a re-set area by setting unit 60. FIG. 26 is a diagram showing an example of the re-setting of a plurality of observation points 6 in the re-set area by setting unit 60. Setting unit 60 reads the observation result of the observation of the movements of the plurality of observation points 6 set in each of observation areas 3o, 3p, and 3q from the memory (not shown), and detects any observation point 6 whose movement is different from those of the other observation points 6. Setting unit 60 then sets areas having a predetermined range including the observation point 6 whose movement is different from those of the other observation points 6 as re-set areas 8a, 8b, 8c, 8d, and 8e (referred to as 8a to 8e, hereinafter). Setting unit 60 then re-sets a plurality of observation points 6 in re-set areas 8a to 8e. For example, as shown in FIG. 26, setting unit 60 may re-set a plurality of observation points 6 in such a manner that the density of observation points 6 is higher in re-set areas 8a to 8e. Alternatively, setting unit 60 may re-set a plurality of observation points 6 in each of re-set areas 8a to 8e in such a manner that the density of observation points 6 is higher only in the vicinity of any observation point 6 whose movement is different from those of the other observation points 6 based on information on the number or positions of the observation points 6 whose movements are different from those of the other observation points 6, for example. In this way, observer 80 can detect not only the movement of subject 1 but also a fine change that occurs in subject 1, such as a strain. Therefore, observer 80 can determine a deteriorated part of subject 1, such as a part where a crack or a cavity has occurred or a part where a crack may occur in the future.

[Effects]

The observation method according to Embodiment 1 includes displaying a video of a subject obtained by imaging the subject, receiving a designation of at least one point in the displayed video, determining an area or edge in the video based on the designated at least one point, setting, in the video, a plurality of observation points in the determined area or on the determined edge, and observing a movement of each of the plurality of observation points in the video.

According to the method described above, by designating at least one point in the video of the subject, the user can determine an area or edge in the video, and easily set a plurality of observation points in the determined area or on the determined edge. Therefore, the user can easily observe a movement of the subject.

For example, in the observation method according to Embodiment 1, the plurality of observation points may be more than the at least one point.

With this configuration, the user can easily set a plurality of observation points in an area of the subject in which the user wants to observe the movement of the subject itself by designating at least one point in the video.

For example, in the observation method according to Embodiment 1, the area determined based on the at least one point may be a quadrilateral area having a vertex in vicinity of the at least one point.

With this configuration, the user can easily designate an area of the subject in which the user wants to observe the movement of the subject itself.

For example, in the observation method according to Embodiment 1, the area determined based on the at least one point may be a round or quadrilateral area having a center in vicinity of the at least one point.

With this configuration, the user can easily designate an area of the subject in which the user wants to observe the movement of the subject itself.

For example, in the observation method according to Embodiment 1, the area determined based on the at least one point may be an area identified as a partial area of the subject.

With this configuration, the user can easily designate an area of the subject in which the user wants to observe the movement of the subject itself.

For example, in the observation method according to Embodiment 1, the area determined based on the at least one point may be an area closest to the at least one point or an area including the at least one point among a plurality of areas identified as a plurality of subjects.

With this configuration, when there are a plurality of subjects in the video, a subject whose movement the user wants to observe can be easily designated by designating at least one point in the vicinity of the subject whose movement the user wants to observe or on the subject whose movement the user wants to observe among these subjects.

For example, in the observation method according to Embodiment 1, in the setting of a plurality of observation points, a plurality of observation point candidates may be set in the video based on the at least one point designated, and a plurality of observation points may be set by eliminating any observation point candidates that does not satisfy an observation point condition from the plurality of observation point candidates.

According to the method described above, an observation point candidate that satisfies an observation point condition can be set as an observation point. The observation point condition is a condition for determining an area that is suitable for observation of the movement of the subject. More specifically, in the method described above, by determining whether an observation point candidate satisfies an observation point condition or not, an area (referred to as an inappropriate area) that is not suitable for observation of the movement of the subject, such as an area in which a blown-out highlight or blocked-up shadow has occurred, an obscure area, or an area in which a foreign matter adheres to the subject, is determined in the video. Therefore, according to the method described above, even if a plurality of observation point candidates are set in an inappropriate area, the inappropriate area can be determined, and a plurality of observation points can be set by eliminating the observation point candidates set in the inappropriate area.

For example, in the observation method according to Embodiment 1, a satisfying degree of each of the plurality of observation points may be displayed in the video, the satisfying degree indicating the degree to which the observation point satisfies an observation point condition.

With this configuration, for example, the user can select observation points having a satisfying degree within a predetermined range from among the plurality of observation points by referring to the satisfying degree of each of the plurality of observation points concerning an observation point condition, and set the observation points as the plurality of observation points.

For example, in the observation method according to Embodiment 1, furthermore, the plurality of observation points may be re-set based on the result of the observation of the movement of each of the plurality of observation points.

With this configuration, for example, when there is any observation point whose movement is different from those of the other observation points in the plurality of observation points, the plurality of observation points may be re-set in such a manner that the density of observation points is higher in a predetermined area including the observation point having the different movement. In the vicinity of the observation point whose movement is different from those of the other observation points, a strain has occurred. Therefore, by setting a plurality of observation points with a higher density in a predetermined area including the observation point having the different movement, the part where the strain has occurred can be precisely determined.

An observation device according to embodiment 1 includes a display that displays a video of a subject obtained by imaging the subject, a receiver that receives a designation of at least one point in the displayed video, a setting unit that determines an area or edge in the video based on the at least one point designated and sets, in the video, a plurality of observation points in the determined area or on the determined edge, and an observer that observes a movement of each of the plurality of observation points.

With the configuration described above, the observation device can determine an area or edge in a video of a subject based on at least one point designated in the video by a user, and easily set a plurality of observation points in the determined area or on the determined edge.

### Embodiment 2

Next, an observation system and an observation device according to Embodiment 2 will be described.

[Observation System and Observation Device]

In Embodiment 1, an example has been described in which, in an observation area, which is an area determined in a video based on at least one point designated by a user, setting unit 60 sets a plurality of observation points more than the at least one point. Embodiment 2 differs from Embodiment 1 in that setting unit 60 sets, on an edge determined based on at least one point designated by a user, a plurality of observation points more than the at least one point. In the following, differences from Embodiment 1 will be mainly described.

FIG. 27 is a schematic diagram showing an example of observation system 300a according to Embodiment 2. As shown in FIG. 27, observation system 300a includes observation device 100a and imaging device 200. Although observation device 100a has the same configuration as observation device 100 according to Embodiment 1, the process flow in setting unit 60 is different. More specifically, the difference is that observation device 100a identifies a plurality of edges of subject 1a, sets a predetermined edge based on at least one point designated by the user among the plurality of identified edges, and sets a plurality of observation points 6 on the certain edge or in an area determined by the certain edge.

For example, observation system 300a takes a video of subject 1a that is a structure having a plurality of cables, such as a suspension bridge or a cable-stayed bridge, receives a designation of at least one point in the taken video, sets a plurality of observation points more than the designated point(s) on an edge (referred to as an observation edge, hereinafter) determined by the designated point(s) in the video, and observes a movement of each of the plurality of observation points. Here, the observation edge is an edge that is closest to the at least one point designated by the user or an edge that overlaps with the at least one point of the plurality of edges identified in the video. In the following, a case where the observation edge is an edge that overlaps with at least one point designated by the user of the plurality of edges identified in the video will be specifically described with reference to the drawings.

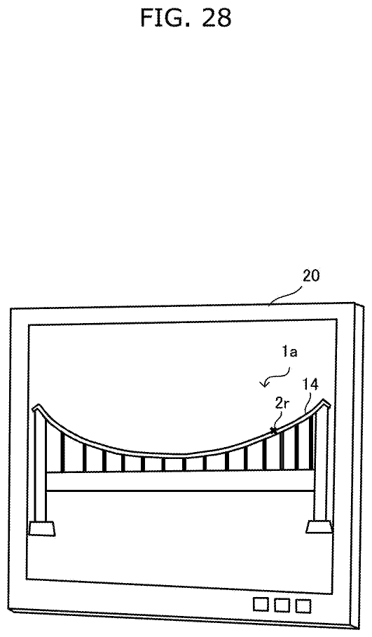

FIG. 28 is a diagram showing an example of the video of subject 1a displayed on display 20. As shown in FIG. 28, display 20 displays a video of subject 1a taken by imaging device 200. Subject 1a is a suspension bridge having cable 14, for example. The user designates point 2r in the video of subject 1a.

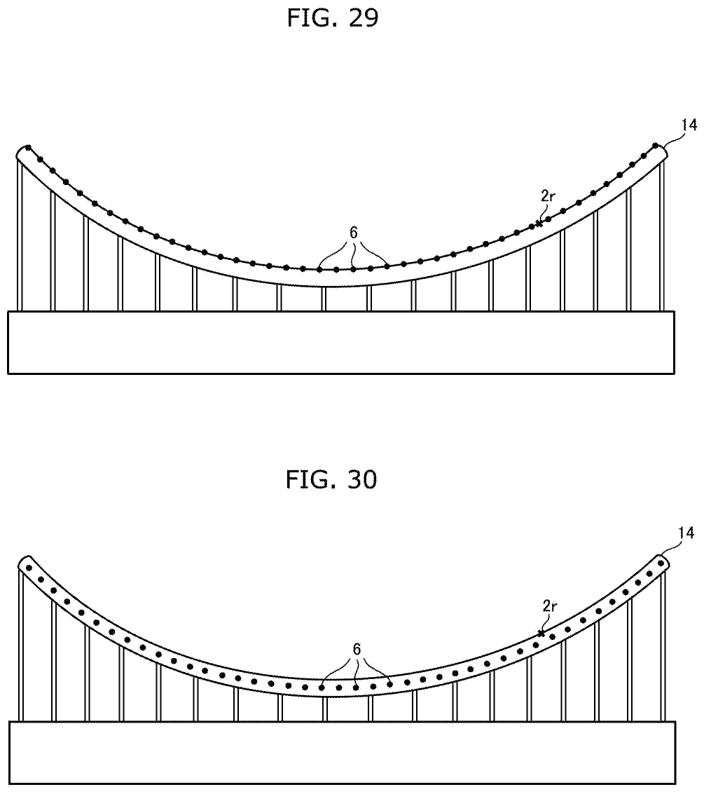

FIG. 29 is a diagram showing an example of a plurality of observation points 6 set on one edge that overlaps with at least one point 2r designated by the user. As shown in FIG. 29, when the user designates one point 2r on an edge of cable 14 in the video, setting unit 60 identifies a plurality of continuous edges in the video, and sets a plurality of observation points 6 on an edge that overlaps with point 2r among the plurality of identified edges. Note that setting unit 60 may set a plurality of observation points 6 on two edges forming one cable 14 among the plurality of identified edges, or set a plurality of observation points 6 between two edges as shown in FIG. 30.

FIG. 30 is a diagram showing an example of a plurality of observation points 6 set between one edge that overlaps with at least one point 2r designated by the user and another edge that is continuous with or close to the one edge. As shown in FIG. 30, when the user designates one point 2r on an edge of cable 14 in the video, setting unit 60 identifies two edges that are continuous with or close to each other in the video, and sets a plurality of observation points 6 between the two identified edges.

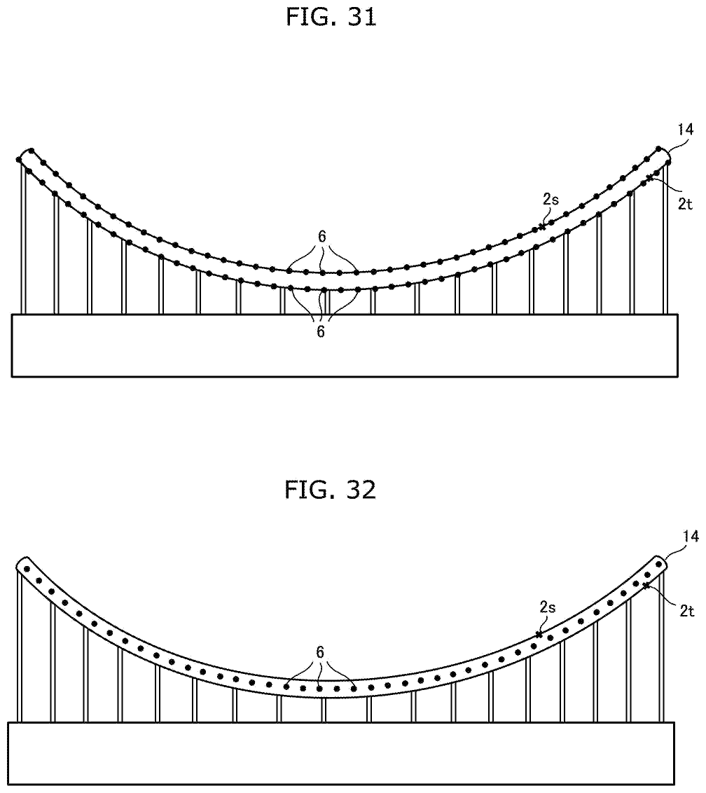

Next, a case where the user designates different edges of cable 14 in the video will be described. FIG. 31 is a diagram showing another example of a plurality of observation points 6 set on two edges that overlap with (i) one point 2s designated by the user or (ii) two or more points 2s and 2t, respectively. As shown in FIG. 31, when the user designates point 2s and point 2t on two different edges of cable 14 in the video, respectively, setting unit 60 identifies a plurality of continuous edges in the video, and sets a plurality of observation points 6 on the edge that overlaps with point 2s and the edge that overlaps with point 2t among the plurality of identified edges.

FIG. 32 is a diagram showing another example of a plurality of observation points 6 set between two edges that overlap with (i) one point designated by the user or (ii) two or more points 2s and 2t designated by the user, respectively. As shown in FIG. 32, when the user designates point 2s and point 2t on two different edges of cable 14 in the video, respectively, setting unit 60 identifies, in the video, one edge that overlaps with point 2s and another edge that is continuous with the one edge and overlaps with point 2t, and sets a plurality of observation points 6 between the two continuous edges.

Note that when the observation edge is an edge that is closest to the at least one point designated by the user of the plurality of edges identified in the video, as with the case described above, a plurality of observation points 6 are set on one continuous edge, on two continuous edges, or between two continuous edges.

[Effects]

For example, in the observation method according to Embodiment 2, the plurality of observation points may be set on an edge determined based on at least one point.

With this configuration, when the subject is an elongated object, such as a cable, a wire, a steel frame, a steel material, a pipe, a pillar, a pole, or a bar, the user can easily set a plurality of observation points on an edge of the subject whose movement the user wants to observe by designating at least one point in the video.

For example, in the observation method according to the aspect of the present disclosure, the edge determined based on at least one point may be an edge that is closest to the at least one point or an edge that overlaps with the at least one point among a plurality of edges identified in the video.

With this configuration, when there are a plurality of edges in the video, the user can easily designate an edge whose movement the user wants to observe by designating at least one point in the vicinity of the edge whose movement the user wants to observe or on the edge whose movement the user wants to observe among these edges.

### Other Embodiments

Although the observation method and the observation device according to one or more aspects of the present disclosure have been described thus far based on embodiments, the present disclosure is not intended to be limited to these embodiments. Variations on the present embodiment conceived by one skilled in the art, embodiments implemented by combining constituent elements from different other embodiments, and the like may be included in the scope of one or more aspects of the present disclosure as well, as long as they do not depart from the essential spirit of the present disclosure.

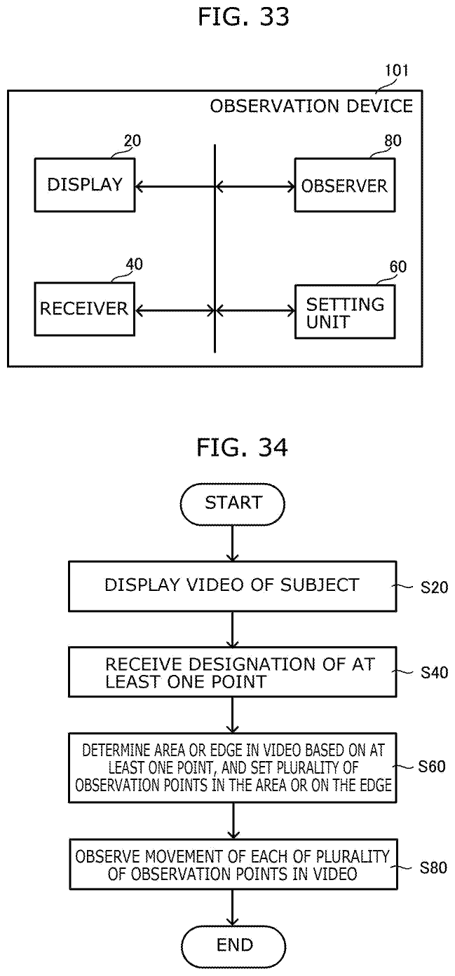

First, an observation device according to another embodiment will be described. FIG. 33 is a block diagram showing an example of a configuration of observation device 101 according to another embodiment.

As shown in FIG. 33, observation device 101 includes display 20 that displays a video of a subject obtained by taking a video of the subject, receiver 40 that receives a designation of at least one point in the displayed video, setting unit 60 that determines an area or an edge in the video based on the designated at least one point and sets a plurality of observation points in the determined area or on the determined edge, and observer 80 that observes a movement of each of the plurality of observation points in the video.

FIG. 34 is a flowchart showing an example of an operation of observation device 101 according to the other embodiment. As shown in FIG. 34, display 20 displays a video of a subject obtained by taking a video of the subject (display step S20). The receiver then receives a designation of at least one point in the video displayed on display 20 in display step S20 (receiving step S40). Receiver 40 outputs information on the designated at least one point to setting unit 60. Setting unit 60 then determines an area or an edge in the video based on the designated at least one point and sets a plurality of observation points in the determined area or on the determined edge (setting step S60). Observer 80 then observes a movement of each of the plurality of observation points in the video (observation step S80).

In this way, the observation device can determine an area or an edge in a video of a subject based on at least one point designated in the video by a user, and easily set a plurality of observation points in the determined area or on the determined edge.

Although a case where the observation system includes one imaging device has been described above with regard to the embodiments described above, for example, the observation system may include two or more imaging devices. In that case, a plurality of taken images can be obtained, and therefore, a three-dimensional displacement or shape of subject 1 can be precisely measured using a three-dimensional reconstruction technique, such as a depth measurement technique based on stereo imaging, a depth map measurement technique, or a Structure from Motion (SfM) technique. Therefore, if the observation system is used for the measurement of a three-dimensional displacement of subject 1 and the setting of observation points described with regard to Embodiment 1 and Embodiment 2, the direction of development of a crack can be precisely determined, for example.

For example, some or all of the constituent elements included in the observation device according to the foregoing embodiments may be implemented by a single integrated circuit through system LSI (Large-Scale Integration). For example, the observation device may be constituted by a system LSI circuit including the obtainer, the deriver, and the extractor.

“System LSI” refers to very-large-scale integration in which multiple constituent elements are integrated on a single chip, and specifically, refers to a computer system configured including a microprocessor, read-only memory (ROM), random access memory (RAM), and the like. A computer program is stored in the ROM. The system LSI circuit realizes the functions of the constituent elements by the microprocessor operating in accordance with the computer program.

Note that although the term “system LSI” is used here, other names, such as IC, LSI, super LSI, ultra LSI, and so on may be used, depending on the level of integration. Further, the manner in which the circuit integration is achieved is not limited to LSIs, and it is also possible to use a dedicated circuit or a general purpose processor. It is also possible to employ a Field Programmable Gate Array (FPGA) which is programmable after the LSI circuit has been manufactured, or a reconfigurable processor in which the connections and settings of the circuit cells within the LSI circuit can be reconfigured.

Further, if other technologies that improve upon or are derived from semiconductor technology enable integration technology to replace LSI circuits, then naturally it is also possible to integrate the function blocks using that technology. Biotechnology applications are one such foreseeable example.

Additionally, rather than such an observation device, one aspect of the present disclosure may be an observation method that implements the characteristic constituent elements included in the observation device as steps. Additionally, aspects of the present disclosure may be realized as a computer program that causes a computer to execute the characteristic steps included in such an observation method. Furthermore, aspects of the present disclosure may be realized as a computer-readable non-transitory recording medium in which such a computer program is recorded.

In the foregoing embodiment, the constituent elements are constituted by dedicated hardware. However, the constituent elements may be realized by executing software programs corresponding to those constituent elements. Each constituent element may be realized by a program executing unit such as a CPU or a processor reading out and executing a software program recorded into a recording medium such as a hard disk or semiconductor memory. Here, the software that realizes the observation device and the like according to the foregoing embodiments is a program such as that described below.

In short, this program makes a computer perform an observation method including displaying a video of a subject obtained by imaging the subject, receiving a designation of at least one point in the displayed video, setting, in the video, a plurality of observation points more than the at least one point based on the designated at least one point, and observing a movement of each of the plurality of observation points.

### INDUSTRIAL APPLICABILITY

The present disclosure can be widely applied to an observation device that can easily set an observation point for observing a movement of a subject.

What is claimed is:

1. An observation method, comprising:
displaying a video of a subject, the video being obtained by imaging the subject;
receiving a designation of at least one point in the video of the subject displayed;
determining an area or edge in the video of the subject based on the at least one point;
setting, in the video of the subject, a plurality of observation point candidates in the area determined or on the edge determined;
evaluating an image of each of a plurality of observation block candidates each having a center point that is a corresponding one of the plurality of observation point candidates, eliminating any observation point candidate not satisfying observation point conditions from the plurality of observation point candidates, and setting remaining observation point candidates among the plurality of observation point candidates to a plurality of observation points; and
observing a movement of the subject itself at each of the plurality of observation points, the movement resulting from applying a certain external load to the subject in the video of the subject, wherein
the observation point conditions for each of the plurality of observation point candidates are that
(i) the subject is present in an observation block candidate corresponding to the observation point candidate,
(ii) image quality of the observation block candidate is good without temporal deformation or temporal blur,
(iii) a displacement of the observation block candidate is observed as not greater than a displacement of any other observation block candidates among the plurality of observation block candidates.

2. The observation method according to claim 1, wherein
a total number of the plurality of observation points is more than a total number of the at least one point.

3. The observation method according to claim 2, wherein
the area determined based on the at least one point is a quadrilateral area having a vertex in vicinity of the at least one point.

4. The observation method according to claim 2, wherein
the area determined based on the at least one point is a round or quadrilateral area having a center in vicinity of the at least one point.

5. The observation method according to claim 2, wherein
the area determined based on the at least one point is obtained by segmenting the video of the subject based on a feature of the video of the subject, the area being identified as a part of the subject.

6. The observation method according to claim 2, wherein
the area determined based on the at least one point is an area closest to the at least one point or an area including the at least one point among a plurality of areas identified as a plurality of subjects.

7. The observation method according to claim 2, wherein
the plurality of observation points are set on the edge determined based on the at least one point.

8. The observation method according to claim 7, wherein
the edge determined based on the at least one point is an edge closest to the at least one point or an edge overlapping the at least one point among a plurality of edges identified in the video of the subject.

9. The observation method according to claim 1, further comprising
displaying, in the video of the subject, a satisfying degree of each of the plurality of observation points, the satisfying degree indicating how much the observation point satisfies the observation point conditions.

10. An observation device, comprising:
a display that displays a video of a subject, the video being obtained by imaging the subject;
a receiving unit that receives a designation of at least one point in the video of the subject displayed;
a setting unit that (i) determines an area or edge in the video of the subject based on the at least one point, (ii) sets, in the video of the subject, a plurality of observation point candidates in the area determined or on the edge determined, (iii) evaluates an image of each of a plurality of observation block candidates each having a center point that is a corresponding one of the plurality of observation point candidates, (iv) eliminates any observation point candidate not satisfying observation point conditions from the plurality of observation point candidates, and (v) sets remaining observation point candidates among the plurality of observation point candidates to a plurality of observation points; and
an observation unit that observes a movement of the subject itself at each of the plurality of observation points, the movement resulting from applying an certain external load to the subject in the video of the subject, wherein
the observation point conditions for each of the plurality of observation point candidates are that
(i) the subject is present in an observation block candidate corresponding to the observation point candidate,
(ii) image quality of the observation block candidate is good without temporal deformation or temporal blur,
(iii) a displacement of the observation block candidate is observed as not greater than a displacement of any other observation block candidates among the plurality of observation block candidates.

11. An observation method, comprising:
displaying a video of a subject, the video being obtained by imaging the subject;
receiving a designation of at least one point in the video of the subject displayed;
determining an area or edge in the video of the subject based on the at least one point;
setting a plurality of observation points in the area determined or on the edge determined;
observing a movement of the subject itself at each of the plurality of observation points, the movement resulting from applying an certain external load to the subject in the video of the subject, and when an observation point has a movement different from a movement of an other observation point among the plurality of observation points, storing, into a memory, a result of the observing of the observation point having the different movement; and
reading the result of the observing from the memory, and re-setting the plurality of observation points to cause a predetermined area including the observation point having the different movement to increase an observation point density.

12. An observation device, comprising:
a display that displays a video of a subject, the video being obtained by imaging the subject;
a receiving unit that receives a designation of at least one point in the video of the subject displayed;
a setting unit that determines an area or edge in the video of the subject based on the at least one point, and sets a plurality of observation points in the area determined or on the edge determined;
an observation unit that observes a movement of the subject itself at each of the plurality of observation points, the movement resulting from applying an certain external load to the subject in the video of the subject, and when an observation point has a movement different from a movement of an other observation point among the plurality of observation points, stores, into a memory, a result of the observing of the observation point having the different movement, wherein
the setting unit reads the result of the observing from the memory, and re-sets the plurality of observation points to cause a predetermined area including the observation point having the different movement to increase an observation point density.
